(19) United States
(12) Patent Application Publication
(10) Pub. No.: US 2024/0119412 A1
(43) Pub. Date: Apr. 11, 2024

(54) RETAILER MANAGEMENT SYSTEM AND METHOD

(71) Applicant: Auto Buffy Inc., Fort Lauderdale, FL (US)

(72) Inventor: Chetan Singh Chadha, Potomac, MD (US)

(21) Appl. No.: 18/481,538

(22) Filed: Oct. 5, 2023

Related U.S. Application Data
(60) Provisional application No. 63/414,798, filed on Oct. 10, 2022.

(51) Int. Cl. G06Q 10/087; G06Q 10/0834; G06Q 30/0601

(52) U.S. Cl. CPC G06Q 10/087; G06Q 10/08345; G06Q 30/0633

(57) ABSTRACT

Managing retail sales by retailer management portal system including receiving, from an electronic commerce marketplace, a marketplace request indicating a request for a customer to purchase an item sold through a retailer, indicating: a marketplace item identifier; a quantity of the item; and a customer location; determining, based on the marketplace item identifier and a marketplace mapping, a retailer item identifier associated with the item; determining, based on the retailer item identifier, a vendor inventory mapping and a vendor shipping mapping, one or more vendor locations to provide the quantity of the item the customer location; and sending, to one or more vendors associated with the one or more vendor locations, one or more fulfillment requests to ship a given quantity of the item to the customer location.

### RELATED APPLICATIONS

This application claims benefit of and priority to U.S. Provisional Patent Application No. 63/414,798 filed Oct. 10, 2022 and titled “RETAILER MANAGEMENT SYSTEM AND METHOD,” the entirety of which is hereby incorporated by reference.

### FIELD

Embodiments relate generally to managing retail sales channels and more particularly to a retailer management portal for managing sales involving electronic commerce marketplaces and vendors.

### BACKGROUND

Retailers often engage in marketing and sales of goods and services to customers (or “consumers”). In the context of the automotive industry, for example, automotive parts (or “auto parts”) retailers often engage in marketing and selling auto parts to car owners, automotive repair shops, and other types of customers. In many instances, retailers operate as intermediaries between customers and suppliers. For example, auto parts retailers may market auto parts to customers, receive auto parts orders from customers, and work with auto parts suppliers (e.g., auto parts warehouses or manufactures) to fulfill the orders. In some instances, suppliers provide the goods to retailers and the retailers, in turn, provide the goods to the customer. In other instances, suppliers provide goods directly to customers. For example, auto parts retailers may engage auto parts suppliers to fulfill auto parts orders, and the suppliers may, in turn, ship auto parts to the customer to fulfill the orders (often referred to as “drop shipping”).

### SUMMARY

Retail sales channels are often complex and, as a result, it can be difficult and time consuming for retailers to effectively and efficiently manage sales channels. This complexity continues to grow as the Internet and electronic commerce (e-commerce) platforms provide retailers with opportunities to interact with an increasing number of suppliers and marketplaces, such as Internet-based (or “online” or “e-commerce”) marketplaces like eBay, Amazon, retail websites and the like. In the e-commerce automotive parts (or “auto parts) industry, for example, auto parts retailers often employ multiple auto parts suppliers to fulfill or otherwise service auto parts orders generated by way of a variety of e-commerce marketplaces, and auto parts suppliers often carry multiple manufacturer brands (e.g., AC Delco, Monroe, NGK, etc.), which can, in turn, provide a single retailer with access to a relatively large number of marketplaces, suppliers and brands. Although increasing opportunity, this level of access can increase choices and complexities of determining how best to optimize order fulfillment. Adding to the number of supplier and brand options, suppliers often have multiple locations, such as multiple warehouses spread across different geographic regions, and may or may not have access to preferred shipping channels. Moreover, when considering how best to fulfill orders, retailers typically desire to identify and employ affordable and reliable suppliers in an effort to increase customer satisfaction and revenue. The incorporation of multiple e-commerce marketplaces such as eBay, Amazon, Walmart, or other third-party e-commerce websites, or a retailer's own e-commerce website, can further complicate optimizing the fulfillment process. Each marketplace platform can have different sales requirements, such as requirements for identifying/labeling products and so forth. For example, for a given item, a first marketplace may employ the manufacturer part number as an item identifier in its system, a second marketplace may use the manufacturer part number as part of an item identifier in its system, and another marketplace may use something other than the manufacturer part number as an item identifier in its system. Further, many e-commerce marketplaces do not provide efficient techniques for grouping multiple items (e.g., “product bundles” or “kits”). As a result, retailers may have to create and track unique bundle (or “kit”) identifiers that are associated with the multiple items in the bundle and provide those to the e-commerce marketplaces (in place of the individual item identifiers) for use in marketing and selling the bundles. Although having a large number of available options can provide flexibility, it can also introduce challenges for confidently and consistently identifying and employing optimal channels for fulfilling orders. This can be increasingly important in the context of e-commerce sales channels and navigating inventory and pricing challenges of supply-chain issues.

Provided are embodiments of a retailer system that employs a retailer management portal (“retailer portal”) to provide efficient and effective management of retail sales channels, including, for example, e-commerce marketplaces and vendors (or “suppliers”). In some embodiments, the retailer portal for a retailer is operable to dynamically update vendor information, such as vendor inventory and shipping information for vendors that service the retailer. For example, the retailer portal of a retailer system served by vendors may continually monitor vendor inventory status, such as item inventory, pricing and shipping information for the vendors, and, in response to changes in vendor status, update associated vendor information, such as a vendor inventory mapping and vendor shipping mapping. In some embodiments, the retailer portal for a retailer provides associated inventory status information to marketplaces that service the retailer for use in populating sales information for items sold though the retailer. For example, the retailer portal for a retailer may determine item inventory, pricing and description information based on information stored in a vendor inventory mapping for the retailer and provide associated inventory status information to marketplaces that service the retailer, for use in populating sales information presented by the marketplaces, for items sold through the retailer. In some embodiments, the retailer portal of a retailer is operable to dynamically respond to marketplace requests, such as those relating to customer requests to purchase one or more items sold through the retailer by way of one or more the marketplaces. For example, the retailer portal for a retailer may continually monitor for marketplace requests associated with customer requests to purchase an item sold through the retailer and, in response to receiving such a request, access and use vendor information, such as a vendor inventory mapping, a vendor shipping mapping or vendor performance information, to select and employ one or more of the vendors that service the retailer to fulfill or otherwise service the request.

Provided in some embodiments is a method of managing retail sales, the method including: receiving, by a retailer management portal system from an electronic commerce marketplace, a marketplace request indicating a request for a customer to purchase an item sold through a retailer, the marketplace request indicating: a marketplace item identifier associated with the item; a quantity of the item to be purchased; and a customer location; determining, by the retailer management portal system based on the marketplace item identifier and a marketplace mapping, a retailer item identifier associated with the item, the marketplace mapping including a mapping of retailer item identifiers employed by the retailer for items sold through the retailer to marketplace item identifiers employed by one or more electronic commerce marketplaces; determining, by the retailer management portal system based on the retailer item identifier, a vendor inventory mapping and a vendor shipping mapping, one or more vendor locations to provide the quantity of the item the customer location, the vendor inventory mapping including a mapping of inventory information for the items sold through the retailer to vendor locations that service the marketplace, and the vendor shipping mapping including a mapping of shipping cost information for the items sold through the retailer to vendor locations that service the marketplace; and sending, by retailer management portal system to one or more vendors associated with the one or more vendor locations, one or more fulfillment requests to ship a given quantity of the item to the customer location.

### BRIEF DESCRIPTION OF THE DRAWINGS

FIG. 1A is diagram that illustrates an e-commerce environment in accordance with one or more embodiments.

FIG. 1B is diagram that illustrates aspects of a retailer management portal in an e-commerce environment in accordance with one or more embodiments.

FIGS. 2A-2F are diagrams that illustrate example retailer information in accordance with one or more embodiments.

FIG. 3 is a diagram that illustrates an example item bundle (or “kit”) and associated information in accordance with one or more embodiments.

FIG. 4 is a diagram that illustrates example aspects of fulfilling an order in accordance with one or more embodiments.

FIG. 5 is a flowchart diagram that illustrates a method of updating vendor information in accordance with one or more embodiments.

FIG. 6 is a flowchart diagram that illustrates a method of fulfilling marketplace requests in accordance with one or more embodiments.

FIG. 7 is a flowchart diagram that illustrates a method of updating vendor feedback information in accordance with one or more embodiments.

FIGS. 8A and 8B are flowchart diagrams that illustrate methods of maintaining and reporting inventory in accordance with one or more embodiments.

FIG. 9 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Described are embodiments of a retailer system that employs a retailer management portal (“retailer portal”) to provide efficient and effective management of retail sales channels, including, for example, e-commerce marketplaces and vendors (or “suppliers”). In some embodiments, the retailer portal for a retailer is operable to dynamically update vendor information, such as vendor inventory and shipping information for vendors that service the retailer. For example, the retailer portal of a retailer system served by vendors may continually monitor vendor inventory status, such as item inventory, pricing and shipping information for the vendors, and, in response to changes in vendor status, update associated vendor information, such as a vendor inventory mapping and vendor shipping mapping. In some embodiments, the retailer portal for a retailer provides associated inventory status information to marketplaces that service the retailer for use in populating sales information for items sold though the retailer. For example, the retailer portal for a retailer may determine item inventory, pricing and description information based on information stored in a vendor inventory mapping for the retailer and provide associated inventory status information to marketplaces that service the retailer, for use in populating sales information presented by the marketplaces, for items sold through the retailer. In some embodiments, the retailer portal of a retailer is operable to dynamically respond to marketplace requests, such as those relating to customer requests to purchase one or more items sold through the retailer by way of one or more the marketplaces. For example, the retailer portal for a retailer may continually monitor for marketplace requests associated with customer requests to purchase an item sold through the retailer and, in response to receiving such a request, access and use vendor information, such as a vendor inventory mapping, a vendor shipping mapping or vendor performance information, to select and employ one or more of the vendors that service the retailer to fulfill or otherwise service the request.

In some embodiments, selection of one or more vendors to service a request is based on one or more of vendor inventory (e.g., determined based on vendor inventory mapping), costs to fulfill the request (e.g., determined based on a price indicated by the vendor inventory mapping and a shipping cost indicated by the ship mapping), or other factors, such as vendor ratings (e.g., determined based on historical vendor performance information). For example, a vendor may be selected to fulfill a request to purchase an item based on the vendor having a lowest total fulfillment cost (e.g., sum of price+shipping cost) of the vendors servicing the retailer that have a rating that satisfies a retailer rating threshold. In some embodiments, the retailer portal provides fulfillment requests to one or more selected vendors for service by the selected vendor(s). For example, in response to selection of vendor A to provide one of item A and vendor C to provide two of item B to fulfill a purchase request initiated by customer A through a first marketplace for a bundle (or “kit”) of items including one of item A and two of item B, the retailer portal may send to vendor A a fulfillment request requesting vendor A send one of item A directly to customer A (e.g., “drop ship” item A to customer A) and send to vendor C a fulfillment request requesting that vendor C send two of item B directly to customer A (e.g., “drop ship” item B to customer A). In some embodiments, the selection of vendors is based on a total price of items to be provided by the vendors. For example, vendor A may be selected based on the total price for vendor A (e.g., the price for item A and the cost of shipping the item A to the customer A from vendor A) being less than the total costs for the other vendors that service the retailer. The costs may, for example, be determined based on item costs determined using the vendor mapping, and estimated shipping costs determined using the ship mapping. In some embodiments, the selection of a vendor is based on a shipping time for items to be provided by the vendor. For example, vendor A may be selected based on an estimated time for delivering item A from vendor A to customer A being less than estimated shipping times of other vendors that service the retailer. The estimated shipping times may, for example, be determined based on shipping estimates provided by a shipping mapping for the retailer, which may include indications of shipping times, for the vendor or a third party, such as a third-party shipping provider, employed to ship the items to fulfill an order. In some embodiments, the selection of a vendor is based on a rating of the vendor. For example, vendor A may be selected based on a ranking of item A from vendor A to customer A being less than estimated shipping times of other vendor A having a highest ranking of similarly situated vendors that service the retailer. Vendor rankings may, for example, be determined based on vendor performance information, such as historical shipping times for vendors, feedback provided for the vendors (e.g., provided by customers, marketplaces, retailers, etc.), or the like. The historical shipping times may, for example, include a characterization of actual delivery times for a vendor, such as deviation of actual delivery times from estimated delivery times, whether they be early or late delivery. The feedback may, for example, include characterizations of vendors based on feedback from other parties, such as satisfaction surveys completed by customers served by the vendors.

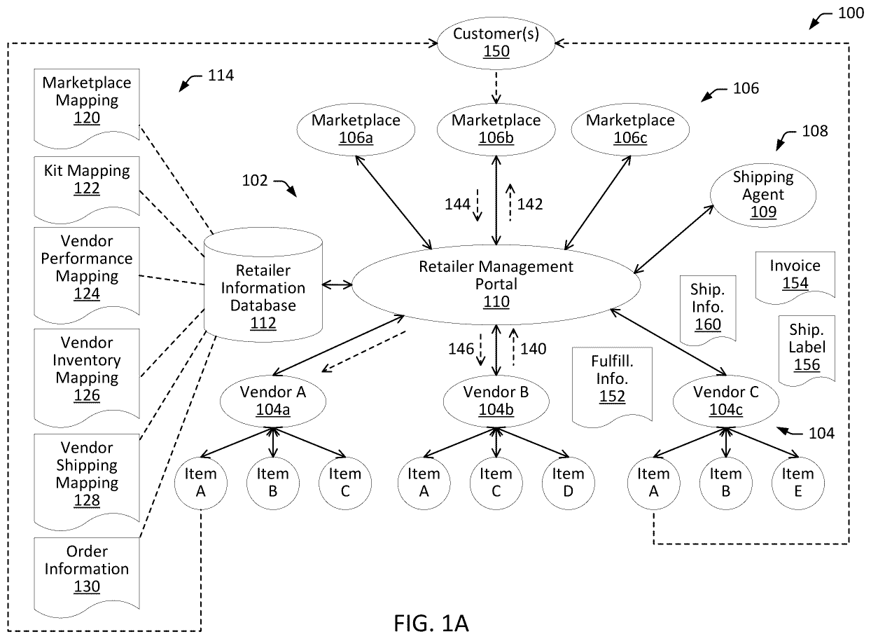

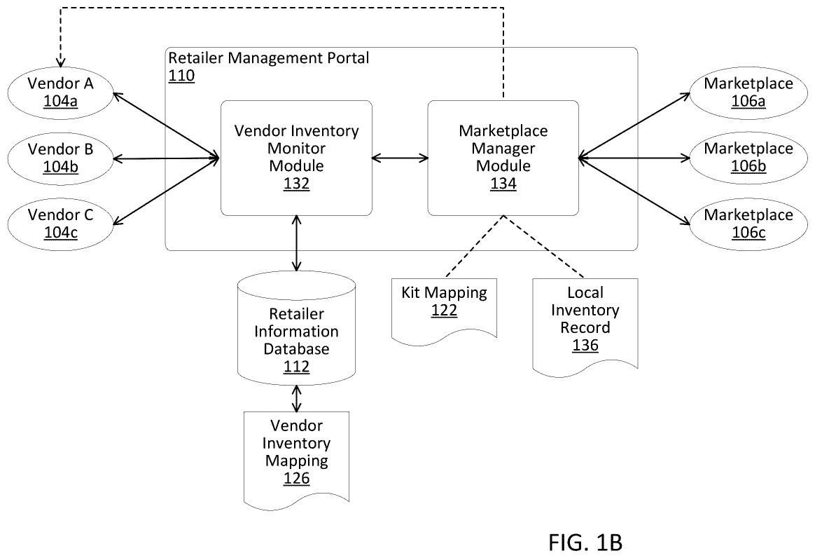

FIG. 1A is a diagram that illustrates an e-commerce environment 100 in accordance with one or more embodiments. In the illustrated embodiment, the e-commerce environment 100 includes a retailer sales system (“retailer”) 102, a vendor system (or “supplier system”) 104 (e.g., including vendors (or “suppliers”) 104a-104c), a marketplace system (or “marketplace”) 106 (e.g., including marketplaces 106a-106c), and a shipping system 108 (e.g., including one or more shipping providers (or “shipping agents”) 109). The retailer 102 includes a retailer management portal system (“retailer management portal”, “retailer portal” or “portal”) 110 and a retailer information database (or “retailer database”) 112 storing associated retailer information 114. The retailer information 114 may include, for example, a marketplace mapping 120, a kit mapping 122, a vendor performance mapping 124, a vendor inventory mapping 126, a vendor shipping mapping 128, or order information 130.

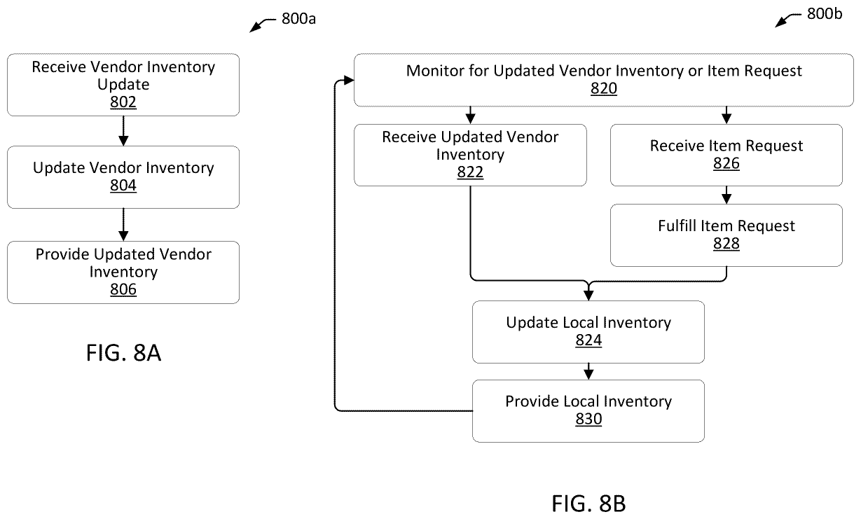

FIG. 1B is diagram that illustrates aspects of a retailer management portal of the e-commerce environment in accordance with one or more embodiments. In the illustrated embodiment, the retailer portal 110 includes a vendor inventory monitor module (“vendor inventory monitor”) 132 and a marketplace manager module (“marketplace manager”) 134. As described, the vendor inventory monitor 132 may communicate with vendors (e.g., vendors 104a-104c) and marketplace manager 134 to maintain the vendor inventory mapping 126. Further, marketplace manager 134 may communicate with the vendor inventory monitor 132 and marketplaces 106 (e.g., marketplaces 106a-106c) to maintain a local inventory record 136. This may include, for example, the following: the marketplace manager module 134 receiving, from the vendor inventory monitor 132 (or a similar source), an indication of current vendor inventory (e.g., a current version of the vendor inventory mapping 126); the marketplace manager module 134 generating or updating the local inventory record 136 based on the indication of current vendor inventory; the marketplace manager module 134 receiving, from one or more marketplaces 106, indications of item purchase requests; the marketplace manager module 134 providing, to one or more vendors 104, associated fulfillment request(s); and the marketplace manager module 134 updating the local inventory record 136 to reflect corresponding fulfillment(s) (e.g., reducing inventory of items held by vendors). In some embodiments, the local inventory record 136 includes indications of available inventory of one or more kits. For example, as described here, the marketplace manager module 134 may determine available inventory of one or more kits of items at a given time based on a kit mapping 122 (e.g., a mapping that is indicative of a number of given items in one or more kits of items) and numbers of associated items determined to be available at the given time. In some embodiments, the vendor inventory monitor 132 periodically (e.g., on a regular basis or responsive to receiving inventory updates from vendors 104, or in response to an inventory query from the marketplace manager 134), updates the vendor inventory mapping 126 and provides a corresponding “current” (or “updated”) version of the vendor inventory mapping 126 to the marketplace manager 134 for use in updating the local inventory record 136. In such an embodiment, the marketplace manager 134 may, in turn, update the local inventory record 136 to reflect the “current” (or “updated”) inventory of the vendors 104. Examples of such processes are described here with regard to at least FIGS. 8A and 8B and methods 800a and 800b.

Such embodiments may enable the marketplace manager 134 to generate and maintain (or “update”) the local inventory record 136 based on an initial set of vendor inventory information, make updates to the local inventory record 136 based on marketplace item requests and fulfillment requests (e.g., without communication with vendor inventory monitor 132 and the associated communication/processing overhead), update marketplaces 106 as to inventory based on marketplace item requests and fulfillment requests (e.g., without communication with vendor inventory monitor 132 and the associated communication/processing overhead), and periodically update the local inventory record 136 to reflect updates to vendor inventory (e.g., to reflect a vendor receiving a new shipment of items, losing one or more items, or the like). Such a system may enable “local” management and communication of inventory with marketplaces 106, which is supplemented with inventory information provided by the vendor inventory monitor 132. This may, for example, reduce communication and processing overhead between the vendor inventory monitor 132 and the marketplace manager 134, while enabling the marketplace manager module to provide relatively up-to-date and accurate inventory information to marketplaces 106 between inventory updates provided by the vendor inventory monitor 132.

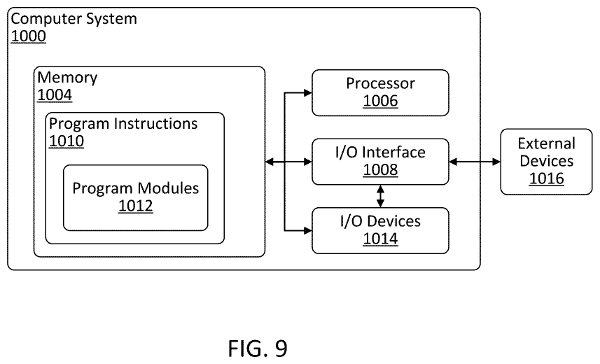

In some embodiments, the retailer system 102, each of some or all of the vendors 104a-104c, each of some or all of the marketplaces 106a-c, or each of some or all of the shipping provider(s) 109 include or otherwise employ a computer system that is the same as or similar to computer system 1000 described with regard to at least FIG. 9. As described, the respective computer system for each of the systems may be employed to execute some or all of the operations described herein, including those described as being performed by the respective system. In some embodiments, the various systems are communicatively coupled by way of one or more electronic communication networks, such as the Internet, a local area network, or the like. In some embodiments, the entities communicate information by way of an application programming interface (API), file transfer protocol (FTP), or manual vendor file upload.

In some embodiments, the retailer portal 110 provides for coordinating marketing, sales and fulfillment operations between vendors, marketplaces and retailers. For example, the retailer portal 110 may be an application employed by a retailer (e.g., serviced by system 102) that provides for collecting vendor information 140 from some or all of the vendors 104-104c, updating of the retailer information 114 (e.g., updating the retailer information 114 stored in the retailer database 112 based on vendor information 140 collected), generating marketplace information 142 (e.g., based on the retailer information 114 stored in the retailer database 112), providing marketplace information 142 to the marketplaces 106a-106c (e.g., for use by marketplaces 106a-106c in presenting items A-E to marketplace customers(s) 150 for purchase), receiving marketplace requests 144 (e.g., including item purchase requests (or “orders”) for items A-E initiated by customers 150), generating and sending fulfillment request 146 to vendors 104a-104c (e.g., including order fulfillment requests 146 for items A-E based on marketplace requests 144, such as customer orders for items A-E), and servicing the fulfillment request 146 (e.g., including the exchange of shipping information 160 or fulfillment information 152 between the vendors 104a-104c, the marketplaces 106a-106c, the shipping providers 109, or the customers 150).

In some embodiments, the retailer portal 110 coordinates shipping services for one or more of the vendors 104a-104c. For example, where vendor A 104a does not have an association with a shipping provider (or requests assistance of the retailer to secure shipping services), the retailer portal 110 may use the retailer's association with the shipping provider 109 to secure shipping services for vendor A 104a. This may include, for example, the retailer portal 110 determining a shipping service and associated cost to ship an item from vendor A 104a to a customer 150 using the shipping provider 109, obtaining associated shipping information (e.g., a shipping label) from the shipping provider 109, and sending the shipping label to vendor A 104a. This may include, for example, the retailer portal 110 employing a shipping API (e.g., Shippo API) to fetch an associated shipping method and shipping cost for vendor A 104a. In such an embodiment, vendor A 104a may, in turn, ship the associated item to the customer 150 using the shipping label. For example, vendor A 104a may package the item in a box, attach the shipping label to the box, and submit the box to the shipping provider 109 for transport to the customer 150. This may, for example, enable relatively small, low volume or less sophisticated vendors that do not have strong relationships with shipping providers, to take advantage of cost savings, simplicity afforded by the retailer's relationship with shipping providers. For example, the retailer may have access to discounted shipping rates based on its relationship with shipping provider 109 and, as a result, can arrange shipping services using the shipping provider 109 to provide vendor with a relatively low cost and simple shipping option.

In some embodiments, the retailer portal 110 conducts vendor inventory operations. Vendor inventory operations may include, for example, collecting vendor information, updating associated retailer information based on the vendor information, and providing corresponding updates to associated marketplaces.

In some embodiments, vendor inventory operations include collecting vendor information from vendors, determining, based on vendor information collected, changes in inventory quantity, pricing or descriptions for items sold through the retailer, or changes in shipping rates for vendors that service the retailer, and updating retailer information to reflect the changes. For example, vendor inventory operations may include the retailer portal 110 collecting vendor information 140 from one or more of the vendors 104a-104c (e.g., by way of API, FTP, or manual vendor file upload), determining, based on the vendor information 140 collected, changes in inventory quantity, pricing or descriptions for one or more of items A-E, or changes in shipping rates for one or more of the vendors 104a-104c or items A-E, and updating the retailer information 114 to reflect the changes. Vendor inventory operations may include, for example, the retailer portal 110 collecting vendor information 140 from vendor A 104a that identifies changes in vendor A's inventory quantity for item A, pricing for item A, and shipping rates for vendor A, determining, based on the vendor information 140 collected from vendor A, the changes in vendor A's inventory quantity for item A, pricing for item A, and shipping rates for vendor A, and updating the retailer information 114 to reflect the changes. In some embodiments, updating associated retailer information based on vendor information includes updating vendor mappings, such as a vendor inventory mapping or a vendor shipping mapping. Continuing with the above example, vendor inventory operations may include the retailer portal 110 updating the vendor inventory mapping 126 to reflect the current inventory quantity and pricing for item A, and updating the vendor shipping mapping 128 to reflect the current shipping rates for vendor A.

In some embodiments, providing corresponding updates to associated marketplaces includes determining changes in retailer information that are relevant to marketplaces that service the retailer, and providing corresponding updates to the marketplaces. For example, vendor inventory operations may include the retailer portal 110 monitoring for changes to the retailer information 114 that are relevant to inventory, pricing, product descriptions or shipping of items A-E sold through the retailer and offered for sale through the marketplaces 106a-106c and, in response to determining such changes, generating, and sending to the marketplaces 106a-106c, updated marketplace information 142 that corresponds to the changes (e.g., by way of API, FTP, or manual vendor file upload). Where for example, marketplaces A and B 106a and 106b offer item A for sale through its e-commerce site, vendor inventory operations may include the retailer portal 110 determining that the retailer information 114 indicates a change in inventory and price of item A, and, in response, generating updated item information 142 that is indicative of the current inventory and price of item A, determining that marketplaces A and B 106a and 106b offer item A for sale through their respective e-commerce sites, and sending the updated item information 142 (indicative of the current inventory and price of item A) to marketplaces A and B 106a and 106b. Marketplaces A and B 106a and 106b may, in turn, update their e-commerce sites (e.g., their respective pages offering item A for sale) to reflect the current inventory and price of item A. For example, marketplaces A and B 106a and 106b may update their sites to display the current inventory and price of item A when users, such as customers 150, navigate to a page offering item A for sale.

In some embodiments, a marketplace mapping is generated and used to facilitate sending and receipt of marketplace information to multiple marketplaces that may employ different item identification schemes. For example, where marketplace A 106a employs a first type of product identifier for each item it sells through its site and marketplace B 106b employs a second type of product identifier for each item it sells through its site, marketplace A 106a and marketplace B 106b may use different identifiers for the same item. For example, for a shock absorber having a manufacturer part number “RS5525”, marketplace A 106a may identify and market that shock absorber using a marketplace identifier of “ASIN-B01JBLRGP2” and marketplace B 106b may identify and market that same shock absorber using a marketplace identifier of “Item_ID-133883480627; Label-RS55255x1”. In some embodiments, a marketplace mapping provides a mapping of each of some or all of the items offered by a retailer to corresponding identifiers (or other item information) for respective ones of some or all of the marketplaces that service the retailer. For example, in the case of the shock absorber having a manufacturer part number “RS5525”, the marketplace mapping 120 may include, for each marketplace that the retailer sells the item through, an entry that maps the manufacturer part number to the marketplace's identifier and other item information, such as a the name of the marketplace, a description of the item to be presented by the marketplace in association with the item, item(s) provided within the item, and an associated price to be charged to the marketplace for the item.

In some embodiments, some or all of the information of a marketplace mapping is populated based on item information provided to the retailer portal 110 by the marketplaces (e.g., marketplaces 106a-106c), obtained by the retailer portal 110 from sites operated by the marketplaces, or other sources. For example, the retailer portal 110 may receive from marketplace A 106a an marketplace identifier of “ASIN-B01JBLRGP2” and an indication that it is associated with the shock absorber having a manufacturer part number “RS5525”, and, in response, the retailer portal 110 may generate an entry in the marketplace mapping 120 that associates manufacturer part number “RS5525” (and associated descriptions and pricing information) with marketplace identifier of “ASIN-B01JBLRGP2”. Such a marketplace mapping 120 may provide for coordination of communications between the marketplace 106a-106c, the retailer portal 110, and vendors 104a-104c.

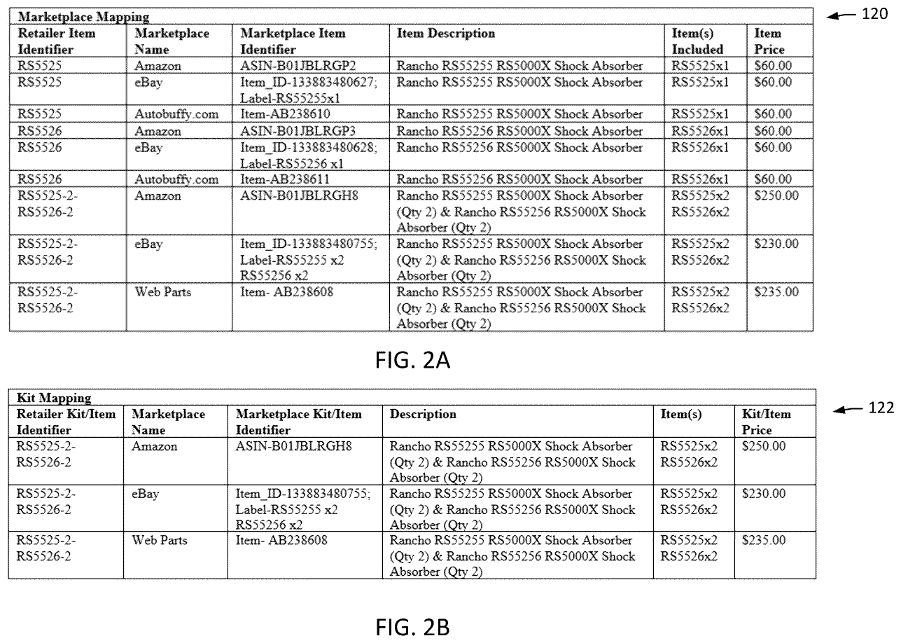

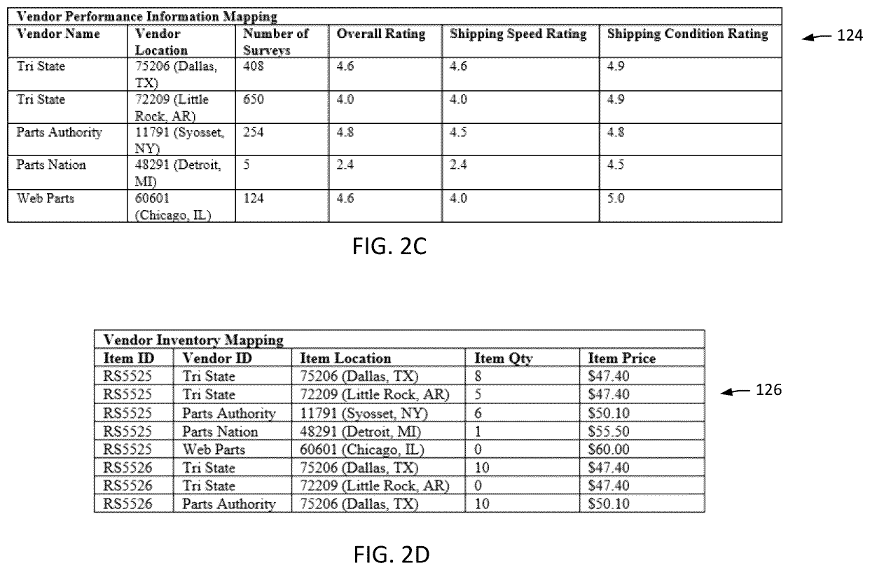

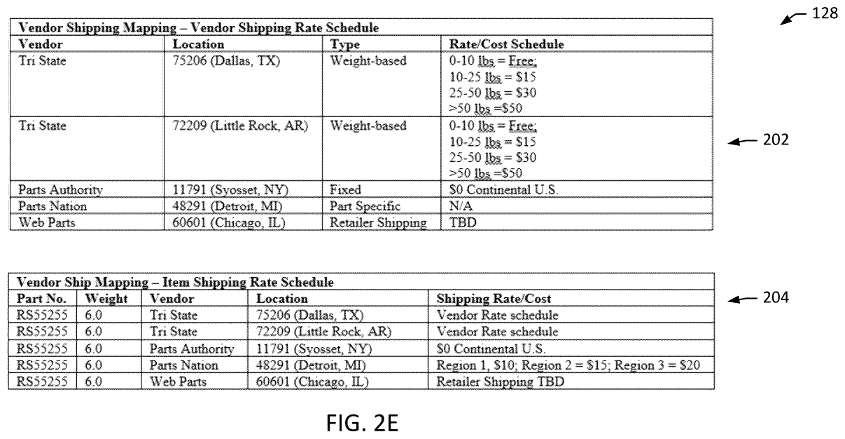

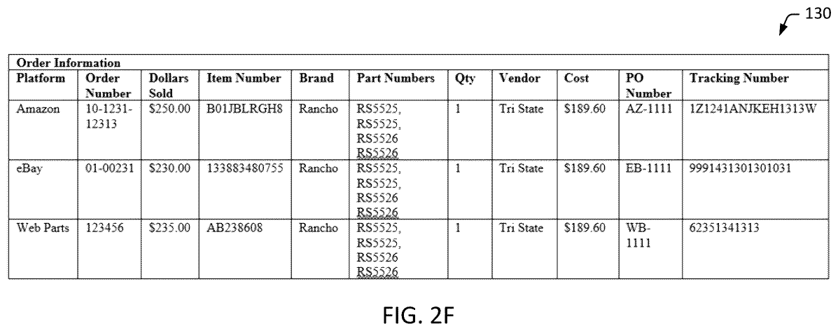

FIG. 2A is a diagram that illustrates an example marketplace mapping 120 in accordance with one or more embodiments. In the illustrated embodiment, the marketplace mapping 120 includes a listing of entries for items offered for sale through a retailer, which map retailer item identifiers (e.g., manufacturer part number employed by a retailer) and associated item information (e.g., item description, a listing of item(s) included, and item price) to corresponding marketplace identifiers (e.g., indicated by a name of the marketplace and the associated marketplace identifier). As described here, this information may be used in coordinating the exchange of information between the retailer portal 110, the marketplaces 106a-106c and the vendors 104a-104. For example, when transmitting marketplace information 142 for the shock absorber having manufacturer part number “RS5525” to the marketplace “Amazon”, the retailer portal 110 may use the marketplace mapping 120 to identify Amazon's corresponding marketplace identifier “ASIN-B01JBLRGP2” and, in turn, indicate with the marketplace information 142 sent to Amazon that the marketplace information 142 is associated with Amazon's item having marketplace identifier “ASIN-B01JBLRGP2”. As another example, in response to receiving a marketplace request 144 from the marketplace “Amazon” associated with marketplace identifier “ASIN-B01JBLRGP2”, the retailer portal 110 may use the marketplace mapping 120 to identify the corresponding retailer item identifier (e.g., manufacturer part number “RS5525”), select a vendor to service the request and, in turn, send an associated fulfillment request to the vendor referencing retailer item identifier (e.g., manufacturer part number “RS5525”).

In some embodiments, a kit mapping is used to facilitate grouping items into “kits”. This may be helpful, for example, in coordinating the marketing and sale of groups of items by way of marketplaces that may not have marketplace identifiers that are associated with the groups. For example, marketplace A 106a may employ a product identifier scheme that relies on a single identifier for each item that is listed and may not directly support use of item identifiers that represent a group of individual items. In such a scenario, to order a group of items, a customer may need to identify and select each item of the group separately, which can be time consuming and lead to errors. For example, to order a set of shock absorbers for a car, a customer may need to order two front shocks (e.g., having manufacturer part number “RS5525”) and two front shocks (e.g., having manufacturer part number “RS5526”) by separately selecting and ordering two of each item. In some embodiments, a kit mapping provides a mapping of item kits (e.g., two or more individual items) to a single identifier that can be employed by the retailer and marketplace to coordinate selection and sale of the group of items. Continuing with the above example, the kit mapping 122 may include, an entry for a shock absorber kit having a single item identifier (e.g., “RS5525-2-RS5526-2”) that maps to associated marketplaces and marketplace identifiers (e.g., “ASIN-B01JBLRGH8” for Amazon, “ITEM-AB238608” for Web Parts, and so forth), identification and quantities of items contained in the kit (e.g., items “RS5525x2” and “RS5526x2”) and other item information associated with the kit, such as a description of the item to be presented by the marketplace in association with the item/kit and an associated price to be charged by the marketplace for the item kit. As a result, a retailer may be able to generate “custom” kits that are recognized and marketed through marketplaces.

In some embodiments, some or all of the information of a kit mapping is populated based popularity of grouping of items. For example, the retailer portal 110 (or the retailer) may identify based on sales history or research, grouping of items that are regularly ordered in the same order, and generate a corresponding kit. In some embodiments, the kit items are incorporated into a marketplace mapping as respective items. For example, in response to the retailer portal 110 receiving a kit mapping 122 (e.g., generated based or sales history or submitted to the retailer portal 110 by retailer personnel), the retailer portal 110 may merge the entries of the kit mapping 122 into the marketplace mapping 120.

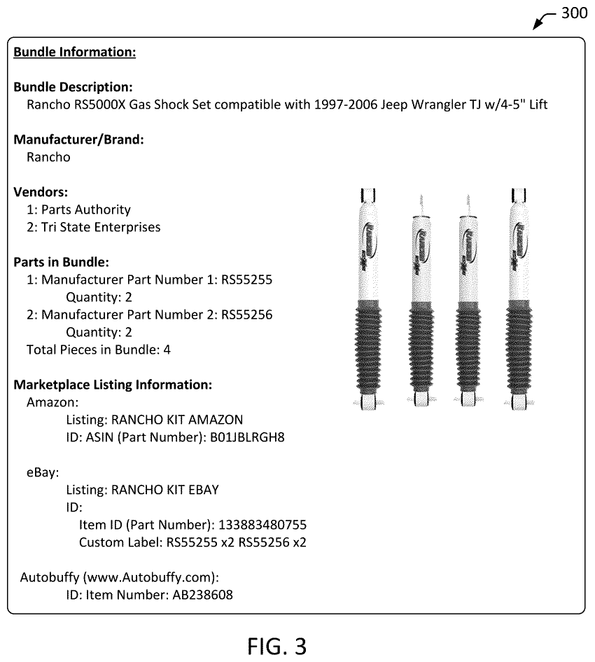

FIG. 3 is a diagram that illustrates an example item bundle (or “kit”) 300 and associated information in accordance with one or more embodiments. FIG. 2B is a diagram that illustrates an example kit mapping 122 in accordance with one or more embodiments. In the illustrated embodiment, the kit mapping 122 includes a listing of entries for groups of items (or “kits”) offered for sale through a retailer, which map a single retailer item identifier (e.g., a “kit identifier”) to multiple items and associated item information. It is noted that the entries for the kit items of the kit mapping 122 are incorporated into the marketplace mapping 120 as respective entries. As described here, this information may be used in the coordinating the exchange of information between the retailer portal 110, the marketplaces 106a-106c and the vendors 104a-104. For example, when transmitting marketplace information 142 for the shock absorber kit having manufacturer part number “RS5525-2-RS5526-2” to the marketplace “Amazon”, the retailer portal 110 may use the marketplace mapping to identify Amazon's corresponding marketplace identifier “ASIN-B01JBLRGH8” and, in turn, indicate with the marketplace information 142 sent to Amazon that the marketplace information 142 is associated with Amazon's item having marketplace identifier “ASIN-B01JBLRGH8”. As another example, in response to receiving a marketplace request 144 from the marketplace “Amazon” associated with marketplace identifier “ASIN-B01JBLRGH8”, the retailer portal 110 may use the marketplace mapping 120 or the kit mapping 122 to identify the corresponding set of items contained in the kit, including two of manufacturer part number “RS5525” and two of manufacturer part number “RS5526”, select one or more vendors to service the request for the four parts and, in turn, send associated fulfillment request(s) to the one or more vendors, including one or more fulfillment requests 146 to supply two of manufacturer part number “RS5525” and one or more fulfillment requests 146 to supply two of manufacturer part number “RS5526”. Accordingly, the kit mapping 122 and associated mappings (e.g., embedded in the marketplace mapping 120) may enable customers and marketplaces to make use of a single item identifier to order a predetermined kit of parts, enable the retailer portal 110 to service a corresponding marketplace request 144 for the kit with one or more fulfillment request 146 for parts contained in the kit.

In some embodiments, the retailer portal 110 conducts marketplace servicing operations. Marketplace servicing operations may include, for example, monitoring for and servicing marketplace requests, such as requests for the purchase of items sold through the retailer through marketplace e-commerce sites. In some embodiments, marketplace servicing operations include monitoring for marketplace requests that include item purchase requests (or “orders”) provided by associated marketplaces, and, in response to receiving such a request, conducting fulfillment operations to service the request. For example, marketplace servicing operations may include the retailer portal 110 monitoring for marketplace requests 144 (from marketplaces 106a-106c) for orders of one or more of items A-E, and, in response to receiving a marketplace request 144 for an order of one or more of items A-E by a customer 150, coordinating with one or more of the vendors 104a-104c (or the shipper provider 109) to provide the one or more of items to the customer 150. For example, marketplace servicing operations may include the retailer portal 110 receiving, from marketplace A 106a, a marketplace request 144 including an order by a customer 150 to purchase item A. The order may include item information, such as a quantity of item A to be purchased (e.g., Item A; Qty=1), and customer information, such as a customer name (e.g., Name=John Doe) and a customer address (e.g., Shipping Address=111 First Street, Phoenix, Arizona 85001). In response to receiving the request 144, the retailer portal 110 may select vendor A 104a to fulfill the request, and, in response, send, to vendor A 104a, a corresponding fulfillment request 146 (e.g., Item A; Qty=1; Name=John Doe; Shipping Address=111 First Street, Phoenix, Arizona 85001).

In some embodiments, vendors employ a shipping service and report corresponding fulfilment information, including shipping information, to the retailer portal. For example, vendor A 104a may, in response to receiving the above fulfillment request 146, employ a shipping provider 109 to ship item A to the customer (e.g., John Doe) at the customer address (e.g., 111 First Street, Phoenix, Arizona 85001). In such an embodiment, vendor A 104a may provide, to the retailer portal 110, fulfillment information 152 that includes shipping particulars. The fulfillment information 152 may include, for example, an invoice 154 (e.g., indicating sales price, shipping cost, and a total cost to be paid by the retailer to the vendor 104a for fulfillment of the associated order) and associated shipping information 160 (e.g., tracking information or shipping status updates). The retailer portal 110 may, in response to receiving the shipping information 160, relay corresponding shipping information (e.g., tracking information or shipping status updates) directly to the customer 150 or to the marketplace A 106a (which may, in turn, relay corresponding shipping information, such as tracking information or shipping status updates, to the customer 150).

In some embodiments, vendors rely on retailer provided shipping services. For example, where a vendor does not have an affiliation with a shipping provider, the vendor may rely on the retailer to coordinate shipping services. In an embodiment in which the vendor relies on retailer provided shipping services, the retailer portal 110 may engage a shipping service to provide shipping, and provide corresponding shipping information to the vendor. Continuing with the above example, in response to receiving the request 144 (including an order by a customer 150 to purchase item A from marketplace A 106a), the retailer portal 110 may determine (e.g., based on an entry for vendor A 104a in vendor ship mapping 128) that vendor A subscribes to retailer provided shipping, and, in response, query the shipping provider 109 for shipping services to ship item A from a location of the vendor A to the customer's address. The shipping provider 109 may, in turn, provide, to the retailer portal 110, shipping information 160, including an associated shipping cost and shipping label 156 (e.g., a shipping label to be attached to a package for shipping item A to John Doe at 111 First Street, Phoenix, Arizona 85001). The retailer portal 110 may send, to vendor A 104a, a fulfillment request 146 indicating order information (e.g., quantity of item A to be shipped to the customer) and the shipping label 156. Vendor A may, in turn, ship item A to the customer (e.g., John Doe) at the customer address (e.g., 111 First Street, Phoenix, Arizona 85001) using the shipping label 156. For example, Vendor A may package item A in a box, affix the shipping label 156 to the box, and submit the box to the shipping provider 109 for transport to the customer 150. In such an embodiment, vendor A 104a may send, to the retailer portal 110, fulfillment information 152 including, for example, an invoice 154 (e.g., indicating sales price and a total amount to be paid by the retailer to the vendor 104a) and associated shipping information 160 (e.g., indicating that item A has been shipped using the shipping label and associated shipping provider 109). The retailer portal 110 may relay corresponding shipping information directly to the customer 150 or to the marketplace A 106a (which may, in turn, relay corresponding shipping information, such as tracking information or shipping status updates, to the customer 150).

In some embodiments, the retailer provides payments to vendors for completing fulfillment requests. Continuing with the above example, the retailer portal 110 may arrange for payment of the total amount of the invoice 154 (including a charge for the fulfillment of the sale of item A to the customer 150) from a financial account of the retailer to a financial account of vendor A 104a, as payment for vendor A 104a fulfilling the order for item A. In some embodiments, the retailer receives payments from marketplaces for completing marketplace requests 144. Continuing with the above example, management portal 110 may issue an invoice to marketplace 106a for an amount associated with fulfillment of the sale of item A to the customer 150, and receive, in a financial account of retailer, payment of the total amount from a financial account of marketplace A 106a, as payment for the retailer completing the marketplace requests 144 for the order for item A by the customer 150.

In some embodiments, the retailer portal 110 conducts customer feedback operations. Customer feedback operations may include, for example, collecting vendor feedback information or processing the vendor feedback information to generate corresponding vendor performance information. In some embodiments, customer feedback operations include collecting vendor feedback information from customers or marketplaces and generating corresponding vendor performance information that includes associated ratings (or “scores”) for respective vendors in one or more rating categories. For example, customer feedback surveys may be distributed to customers 150 that are supplied items by vendors 104a-104c, the survey results may be provided to the retailer portal 110, and the retailer portal 110 may generate a vendor performance mapping 124 that includes ratings of the respective vendors 104a-104c in one or more categories, such as an overall rating, a shipping speed rating, and shipping condition rating. Such ratings may enable assessment of a respective vendor's ability to fulfill orders with items that arrive relatively quickly and in good condition.

FIG. 2C is a diagram that illustrates example vendor performance mapping 124 in accordance with one or more embodiments. In the illustrated embodiment, the vendor performance mapping 124 includes entries that map feedback to respective vendor locations. For example, for each vendor/location, the mapping 124 includes an entry associated with a vendor identifier (e.g., vendor name), a vendor location (e.g., a zip code, city or state of the vendor location), a number of surveys (e.g., a total number of surveys received for the vendor/location), an overall rating (e.g., indicating an overall rating/score for the vendor/location based on satisfaction surveys), a shipping speed rating (e.g., indicating an overall rating/score for the vendor/location based on satisfaction survey responses regarding the speed of shipping/delivering items delivered from the vendor/location), and a shipping condition rating (e.g., indicating an overall rating/score for the vendor/location based on satisfaction survey responses regarding the condition of item delivered from the vendor/location). As described here, this information may be used in the selection vendors for servicing marketplace requests.

In some embodiments, vendors are selected to optimize fulfilling of marketplace requests. For example, one or more vendors may be selected to fulfill a marketplace request to optimize revenue and customer satisfaction. In some embodiments, vendors are selected to fulfill marketplace requests based on vendor inventory. For example, in response to receiving a marketplace request 144 for three of item A, the retailer portal 110 may determine (e.g., based on vendor inventory mapping 126) that each of vendor A 104a and vendor B 104b have at least three of item A in inventory and select vendor A 104a or vendor B 104b to service the marketplace request 144 and, in turn, send an associated fulfillment request 146 to the selected vendor. As another example, in response to receiving a marketplace request 144 for three of item A, the retailer portal 110 may determine (e.g., based on vendor inventory mapping 126) that vendor A 104a has one of item A in stock and vendor B 104b has two of item A in stock and, in response, select vendor A 104a and vendor B 104b to service the marketplace request 144, and send a first fulfillment request for one of item A to vendor 104a and send a second fulfillment request 146 for two of item A to vendor 104b.

In some embodiments, vendors are selected to fulfill marketplace requests based on shipping speed. For example, in response to receiving a marketplace request 144 for three of item A, the retailer portal 110 may determine (e.g., based on vendor inventory mapping 126) that each of vendor A 104a and vendor B 104b have at least three of item A in inventory, and that shipping from vendor A 104a to the customer address will take less time than from vendor B 104b, and, in response, select vendor A 104a to service the marketplace request 144, and send an associated fulfillment request 146 to vendor A 104a.

In some embodiments, vendors are selected to fulfill marketplace requests based on shipping distance. For example, in response to receiving a marketplace request 144 for three of item A, the retailer portal 110 may determine (e.g., based on vendor inventory mapping 126) that each of vendor A 104a and vendor B 104b have at least three of item A in inventory, and that vendor A 104a is closer to the customer address than vendor B 104b, and, in response, select vendor A 104a to service the marketplace request 144, and send an associated fulfillment request 146 to vendor A 104a.

In some embodiments, vendors are selected to fulfill marketplace requests based on cost. For example, in response to receiving a marketplace request 144 for three of item A, the retailer portal 110 may determine (e.g., based on vendor inventory mapping 126) that each of vendor A 104a and vendor B 104b have at least three of item A in inventory, determine that vendor A 104a has a lower total cost (item price+shipping cost for three of item A) than vendor B 104b (e.g., based on price determined from the vendor inventory mapping 126 and shipping cost determined from the vendor shipping mapping 128). The retailer portal 110 may select vendor A 104a to service the marketplace request 144 based on the determinations (e.g., the determination that vendor A 104a has the lowest total cost of the vendors 104a and 104b that service the retailer and have three of item A in stock), and, in turn, send an associated fulfillment request 146 to vendor A 104a. As another example, in response to receiving a marketplace request 144 for three of item A, the retailer portal 110 may determine (e.g., based on vendor inventory mapping 126) that vendor A 104a has one of time A in stock, vendor B 104b has two of item A in stock and vendor C has five of item A in stock, determine that a combination of ordering one of item A for vendor A 104a and two of item A from vendor B 104b provides a lowest overall cost for items in inventory (e.g., vendor C has a higher total cost for item A than vendors A or B). The retailer portal 110 may select vendor A 104a and vendor B 104b to service the marketplace request 144 based on the determination, and, in turn, send to vendor 104a a first fulfillment request to send one of item A to the customer 150 and send to vendor 104b a second fulfillment request 146 to send two of item A to the customer 150. In some embodiments, cost is determined based on vendor mappings. For example, the price for an item offered by a vendor may be determined based on a price for the item/vendor indicated in the vendor inventory mapping 126, a shipping cost for an item offered by a vendor may be determined based on a shipping cost for an item/vendor indicated in the vendor ship mapping 128. A total cost for an item ordered from a vendor may be determined based on a sum of the price and shipping cost for the item/vendor.

In some embodiments, one or more vendors are selected to fulfill requests based on vendor performance information. For example, the retailer portal 110 may select (or not select) vendor A 104a to fulfill marketplace requests 144 based on one or more performance scores/ratings for vendor A 104a stored in vendor performance mapping 124.

In some embodiments, one or more vendors are selected to fulfill an order based on the vendor(s) having a highest overall rating out of vendors capable of fulfilling the order. For example, the retailer portal 110 may select vendor A 104a to fulfill an order for item A based on a determination (e.g., using vendor performance mapping 124) that vendor A 104a has the highest overall rating out of the vendors capable of fulfilling an order for item A.

In some embodiments, one or more vendors are selected to fulfill an order based on the vendor(s) having a rating that satisfies a threshold vendor rating. For example, the retailer portal 110 may select vendor A 104a to fulfill an order for item A based on a determination (e.g., based on the vendor inventory mapping 126 and vendor shipping mapping 128) that vendor A 104a has the lowest total cost (price+shipping) out of vendors capable of fulfilling an order for item A and having an overall rating above an overall rating minimum.

In some embodiments, one or more vendors are selected to fulfill an order based on a weighting of different factors, such as a combination of available inventory, shipping speed, cost, vendor performance information, or the like. For example, the retailer portal 110 may select vendor A 104a to fulfill an order for item A based on a determination that vendor A 104a has the overall highest weighted rating/score out of vendors capable of fulfilling an order for item A. In some embodiments, a weighted rating/score for a vendor is determined based on weighting of one or more ratings/score for the vendor. For example, a weighted rating/score for a vendor may be determined according to the following equation:

Vendor_{score}=A*Rₒᵥₑᵣₐₗₗ+B*R_{shipping_speed}+C*R_{shipping_condition} (1),

where Vendor_{score} is the weighted vendor score, A, B and C are each a weighting parameter, Rₒᵥₑᵣₐₗₗ is an overall rating for the vendor, R_{shipping_speed} is a shipping speed rating for the vendor, and R_{shipping_condition} is a shipping condition rating for the vendor.

In some embodiments, collecting vendor information includes issuing queries for vendor information. For example, collecting vendor information 140 may include the retailer portal 110 issuing queries for vendor information 140 to one or more of the vendors 104a-104c (e.g., at regular intervals or in accordance with an inventory request schedule) and receiving corresponding vendor information 140. In some embodiments, collecting vendor information includes pushing of vendor information. For example, one or more of the vendors 104a-104c may push vendor information 140 to the retailer portal 110 (e.g., at regular intervals or in accordance with an inventory request schedule), and the retailer portal 110 may receive the vendor information 140 pushed from one or more of the vendors 104a-104c.

In some embodiments, vendor information for a vendor includes vendor inventory and vendor shipping information for items provided by the vendor. For example, vendor information 140 for vendor A 104a may include inventory and pricing information for items A, B and C, which are available for sale through marketplaces 106a-106c that service the retailer.

In some embodiments, inventory information for a vendor includes quantities, locations, descriptions, or pricing of items offered by the vendor. For example, inventory information for vendor A 104a may include, for each of item A, B and C, which are available for sale through marketplaces 106a-106c that service the retailer), locations where the items are stocked (or will ship from) (e.g., zip codes of warehouses of vendor A that house the item), quantities of the item at the respective locations, a description of the item (e.g., part number and name of the item), and a price of the item (e.g., a price that the vendor 104 will charge the retail management portal 110 or the marketplace 106 for sale of the item to a customer). The locations may be used, for example, to determine cost for shipping items from the vendor to customers or other locations.

In some embodiments, shipping information for a vendor includes information to facilitate determining costs for shipping items from the vendor to customers or other locations. For example, where a vendor has a fixed rate, such as free shipping to all customers in the continental U.S., the shipping information for the vendor may include a shipping rate schedule that indicates the fixed rate. Where, for example, a vendor calculates shipping cost based on weight (or “weight-based” shipping pricing), the shipping information for the vendor may include a shipping rate schedule including a mapping of item weight ranges to corresponding shipping costs. Where, for example, a vendor calculates shipping costs based on shipping distance or shipping to a given region/location (“distance-based” or “location-based” shipping pricing), the shipping information for the vendor may include a shipping rate schedule including a mapping of shipping distance or destination region/location to corresponding shipping costs. Where, for example, a vendor does not employ its own shipping service (e.g., the vendor does not have an account or other association with a shipping partner or similar service, or request for the retailer to provide shipping services), the shipping information for the vendor may provide a corresponding indication (e.g., “retailer shipping”). As descried in more detail here, in such an embodiment, shipping cost may be determined by the retailer portal 110 based on relationships with a shipping partner. For example, where item A is to be shipped from a location of vendor A 104a to a customer 150 and vendor 104a request that the retailer provide shipping services, the retailer portal 110 may determine a shipping rate for shipping provider 109 shipping item A from the vendor location to the location of the customer 150, and the shipping rate may be used to determine a shipping cost or total cost (e.g., price+shipping rate) to sell and ship item A to the customer 150. This may include, for example, the retailer portal 110 employing a shipping API (e.g., Shippo API) to fetch an associated shipping method and shipping cost for the vendor.

In some embodiments, vendor mappings, such as the vendor inventory mapping 126 and the vendor ship mapping 128, reflect vendor information 140 collected for one more vendors. For example, the vendor inventory mapping 126 may reflect inventory information collected from one or more of vendors 104a-104c, and the vendor ship mapping 128 may reflect shipping information collected from one or more of vendors 104a-104c.

In some embodiments, a vendor inventory mapping includes a record of inventory information for items offered for sale through the retailer. For example, the vendor inventory mapping 126 may include, for each of some or all items sold through marketplaces 106 that service the retailer served by the retailer portal 110, an item identifier (e.g., a part number, a universal product code (UPC) code, or the like), an item description (e.g., a textual description or images of the product), inventory quantity (e.g., a number of the items available), location information (e.g., a zip-code of a warehouse that houses the item or from which the item will be shipped), and pricing information (e.g., a price for the item at the vendor/location). In some embodiments, some or all of the information of vendor inventory mapping 126 is populated based on inventory location information, pricing information, or product descriptions for items provided to the retailer portal 110 by vendors (e.g., vendors 104a-104c) or other sources. For example, in response to the retailer portal 110 obtaining inventory information from vendor A 104a for an item at a given location (e.g., by way of retailer portal 110 querying vendor 104a for the information or a push of the information by vendor A 104a to the retailer portal 110), the retailer portal 110 may make corresponding updates to the information for the respective item/vendor/location in the vendor inventory mapping 126.

FIG. 2D is a diagram that illustrates an example vendor inventory mapping 126 in accordance with one or more embodiments. In the illustrated embodiment, the vendor inventory mapping 126 includes a listing of entries for parts available from respective vendor locations. For each item/vendor/location combination, the mapping 126 includes an item identifier (e.g., part number), a vendor identifier (e.g., vendor name), an item location (e.g., a zip code, city or state of a vendor location where the item is held or will be shipped from), an item quantity (e.g., a quantity indicating a number of the item that is available from the vendor location), and an item price (e.g., a price indicating a cost for purchasing the item from the vendor/location). As described here, this information may used in the selection vendors for servicing of purchase requests or may be used as a basis for generating information (e.g., marketplace information 142) used for updating marketplaces.

In some embodiments, a vendor ship mapping (e.g., vendor shipping mapping 128) includes a record of shipping costs (known or estimated) for some or all items sold through marketplaces that service the retailer. For example, for each of some or all items sold through marketplaces 106 that service the retailer serviced by the retailer portal 110, the vendor ship mapping 128 may include, for each of some or all of the vendors and associated locations that stock the item (e.g., for each location of a warehouse that stocks the item) information for determining a cost for shipping the item to a customer, such as an estimated cost or known cost for shipping the item to a customer, or a formula, table, or other information that can be used to determine a cost for shipping an item to a customer. Where, for example, a vendor does not provide shipping information, or a vendor has selected to receive shipping through the retailer portal 110 (or “retailer shipping”) for an item or location, the shipping information may be determined based on historical shipping rate for the vendor or cost for shipping provided through the retailer portal 110. For example, the shipping information may be predetermined and populated based on rates provided by a third-party a shipping service (or “shipper”) 140 with which the retailer portal 110 is associated. As a further example, the shipping information may be determined by the retailer portal 110, based on rates provided by a third-party shipping service (e.g., the shipping provider 109) with which the retailer (and retailer portal 110) is associated. In an embodiment in which vendor A 104a indicates that all items have free shipping to all addresses in the continental U.S. from its warehouse locations, the vendor ship mapping 128 may include an entry for each item/location associated with the vendor 104a that indicates a fixed cost of shipping of $0 to all addresses in the continental U.S. In an embodiment in which vendor B 104b indicates that items have a fixed cost of shipping of $10 to all addresses in the continental U.S. from a given warehouse location, the vendor ship mapping 128 may include an entry for the item/vendor/warehouse location that indicates a fixed cost of shipping of $10 to all addresses in the continental U.S. In in an embodiment in which vendor C 104c indicates that item A has costs of shipping of $10, $15 and $20 to first, second and third regions, respectively, to addresses in the continental U.S. from a given warehouse location, the vendor ship mapping 128 may include an entry for the item/vendor/warehouse location that indicates a costs of shipping of $10, $15 and $20 to addresses in the first, second and third regions, respectively.

FIG. 2E is a diagram that illustrates an example a vendor ship mapping 126 in accordance with one or more embodiments. In the illustrated embodiment, the vendor ship mapping 128 includes a vendor ship rate mapping (or “vendor shipping rate schedule”) 202 and an item ship rate mapping (or “item ship rate schedule”) 204. In the illustrated embodiment, the vendor shipping rate schedule 202 includes rate schedules for each of different vendor locations. In the illustrated embodiment, the item ship rate schedule 204 includes rate schedules for each of different respective item/vendor/location combinations. In some embodiments, the rate schedule entry for a respective vendor/location or item/vendor/location is based on rate schedule information provided by the respective vendor. For example, the vendor Parts Authority may provide to the retailer portal 110 vendor information 140 that includes a fixed rate schedule indicating free shipping for products offered by Parts Authority, and the retailer portal 110 may process the vendor information 140 and populate the corresponding portion of the vendor shipping rate schedule 202 with the indication of free shipping. In some embodiments, the rate schedule entry for a respective vendor/location is based on rate schedule information derived from historical shipping rates. For example, the weight-based rate schedule for the vendor Tri State may be determined and populated by the retailer portal 110 based on historical shipping costs charged to the retailer portal 110 by the two respective Tri State locations or otherwise observed by retailer portal 110 as being charged by the two respective Tri State locations. Where, for example, retailer-shipping is employed, the shipping rate may be determined based on a shipping rate provided by a shipping provider, such as shipping provider 109. In some embodiments, the rate schedule entry for a respective item/vendor/location is based on rate schedule information provided by the respective vendor, or from a corresponding rate schedule entry of the vendor shipping rate schedule 202, for the vendor/location. For example, the “$0 Continental U.S.” shipping rate for part no. “RS55255” from Parts Authority's Syosset, New York warehouse may be determined based on the “Fixed” shipping type and rate schedule of “$0 Continental U.S.” listed in the associated vendor shipping rate schedule 202.

In some embodiments, the retailer stores historical order information. For example, the retailer portal 110 may store records for respective orders in order information 130. The order information may be used, for example, for reporting order status to marketplaces or customers, generating invoices for payment by marketplaces, or the like. FIG. 2F is a diagram that illustrates example order information 130 in accordance with one or more embodiments. In the illustrated embodiment, the order information 130 includes entries for respective sales of items, including identifying the marketplace (or “platform”), order number, order amount (or “dollars sold”), item number of the item sold, brand of the item sold, part numbers (e.g., in the kit of the item sold), quantity of the item sold vendor(s) that fulfilled the sale of the item, the cost of the item (e.g., the price charged by the vendor for the item(s)), a purchase order number (or “PO Number”) and a tracking number (e.g., for the shipping label(s) used to ship the item).

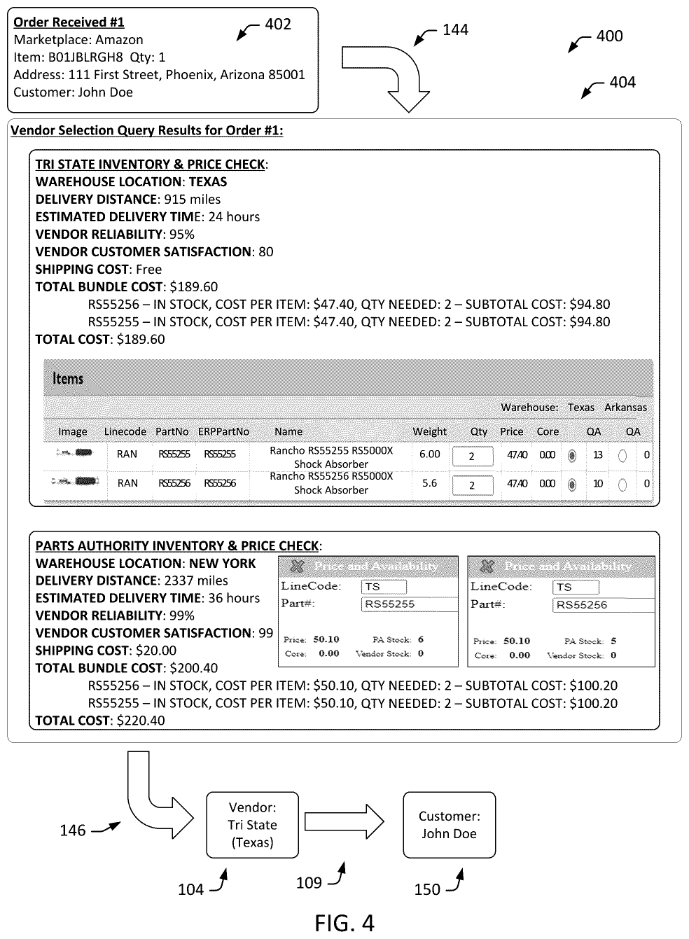

FIG. 4 is a diagram that illustrates example aspects of fulfilling an order in accordance with one or more embodiments. In one embodiment, for example, a marketplace may receive an order (e.g., order received #1) 402, send an associated marketplace request 144 to the retailer portal 110, the retailer portal 110 may determine, based on retailer information 114 (e.g., marketplace mapping 120, a kit mapping 122, a vendor performance mapping 124, a vendor inventory mapping 126, a vendor shipping mapping 128) vendor comparison information 404, and select, based on the comparison a given vendor and vendor location (e.g., Tri State's Texas warehouse location) to fulfill the marketplace request 144, and send, in response to the selection, a corresponding fulfillment request 146 to the selected vendor (e.g., send to Tri State's Texas warehouse location, a fulfillment request 144 to send two of each of RS55256 and RS55255 to John Doe at 111 First Street, Phoenix, Arizona 85001). In such an embodiment, the selected vendor may fulfill the order by shipping the requested items to the customer (e.g., shipping two of each of RS55256 and RS55255 to John Doe at 111 First Street, Phoenix, Arizona 85001, using the shipping provider 109).

Referring again to FIG. 1B, an example process of maintaining and reporting inventory may include the following:
Receive Vendor Inventory Updates—Vendor inventory monitor 132 receives vendor information 140, including inventory information for each of Vendor A, Vendor B and Vendor C (e.g., via an hourly update of inventory quantities—@ 1 pm Vendor A=8 of item A and 1 of item D, Vendor B=4 of item C, and Vendor C=3 of item B, 6 of item C and 7 of item D).
Update Vendor Inventory—Vendor inventory monitor 132 updates the vendor inventory mapping 126 to reflect current inventory (e.g., @ 1 pm update vendor inventory mapping 126 to reflect Vendor A=8 of item A and 1 of item D, Vendor B=4 of item C, and Vendor C=3 of item B, 6 of item C and 7 of item D).
Inform Marketplace Manager of Current Vendor Inventory—Vendor inventory monitor 132 notifies marketplace manager 134 of current inventory (e.g., via an hourly update of inventory-@ 1 pm inventory monitor 132 notifies marketplace manager 134 of Vendor A=8 of item A and 1 of item D, Vendor B=4 of item C, and Vendor C=3 of item B, 6 of item C and 7 of item D).
Determine Current Item/Kit Inventories & Updates Local Inventory Record—@ 1 pm marketplace manager 134 determines, based on notification from vendor inventory monitor 132 and kit mapping 122 and based on max number of kits that can be assembled from available items), current item/kit inventory of A=8, B=3, C=10 (i.e., 4+6), D=8; Kit AB=3, Kit AC=8, Kit BC/DC=10 (where D and B are interchangeable in the kit to pair with C), and marketplace manager 134 updates local inventory record 136 to reflect item/kit inventories.
Push Current Item/Kit Inventories to Marketplaces—@1 pm, marketplace manager 134 sends (e.g., via a push), to marketplaces 106a, 106b and 106c, marketplace information 142 that indicates the current item/kit inventory of A=8, B=3, C=10, D=8; Kit AB=3, Kit AC=8, Kit BC/DC=10.
Marketplace Inventory Update—Marketplaces 106a, 106b and 106c present (e.g., display) current inventories for respective items and kits based on 1:00 pm marketplace information 142.
Receive Request to Purchase Item/Kit—@1:15 pm marketplace manager 134 receives, from marketplace 106b, a request to purchase qty 1 of item B.
Select Vendor for Fulfillment—Marketplace manager 134 selects Vendor C to fulfill item purchase request to purchase qty 1 of item B, and sends corresponding fulfillment request 146 to Vendor C.
Current Item/Kit Inventories & Update Local Inventory Record—@ 1:15 pm marketplace manager 134 determines (based on purchase of qty 1 of item B @1:15 pm and current local inventory record 136) current item/kit inventory of A=8, B=2 (e.g., 3−1), C=10, D=8; Kit AB=2 (e.g., because now only 2 of item B available), Kit AC=8, Kit BC/DC=10, and marketplace manager 134 updates local inventory record 136 to reflect item/kit inventories.
Push Current Item/Kit Inventories to Marketplaces—@1:15 pm, marketplace manager 134 sends, to marketplaces 106a, 106b and 106c, marketplace information 142 that indicates the current item/kit inventory of A=8, B=2, C=10, D=8; Kit AB=2, Kit AC=8, Kit BC/DC=10.
Marketplace Inventory Update—Marketplaces 106a, 106b and 106c present (e.g., display) current inventories for respective items and kits based on 1:15 pm marketplace information 142.
Receive Request to Purchase Item/Kit—@1:30 pm marketplace manager 134 receives, from marketplace 106c a request to purchase qty 1 of item D.
Select Vendor for Fulfillment—Marketplace manager 134 selects Vendor C to fulfill item purchase request to purchase qty 1 of item D, and sends corresponding fulfillment request 146 to Vendor C.
Current Item/Kit Inventories & Update Local Inventory Record—@ 1:30 pm marketplace manager 134 determines (e.g., based purchase of qty 1 of item D and current local inventory record 806) a current item/kit inventory of A=8, B=2, C=10, D=7 (e.g., 8−1); Kit AB=2, Kit AC=8, Kit BC/DC=9 (e.g., based on reduced/total availability of B & D—only 9 total of items B & D available), and updates local inventory record 136 to reflect item/kit inventories.
Push Current Item/Kit Inventories to Marketplaces—@1:30 pm, marketplace manager 134 sends (e.g., via a push), to marketplaces 106a, 106b and 106c, marketplace information 142 that indicates the current item/kit inventory of A=8, B=2, C=10, D=7; Kit AB=2, Kit AC=8, Kit BC/DC=9.
Marketplace Inventory Update—Marketplaces 106a, 106b and 106c present (e.g., display) current inventories for respective items and kits based on 1:30 pm marketplace information 142.
Receive Vendor Inventory Updates—@ 2 pm Vendor inventory monitor 132 receives vendor information 140, including inventory information for each of Vendor A, Vendor B and Vendor C (e.g., via an hourly update of inventory quantities—@ 1 pm Vendor A=8 of item A and 1 of item D, Vendor B=4 of item C, and Vendor C=10 of item B, 6 of item C, and 7 of item D—this may reflect the fulfilment of qty 1 of item B by Vendor C, the fulfilment of qty 1 of item D by Vendor C, and Vendor C receiving/intaking a shipment of 8 of item B between 1 pm and 2 pm (e.g., B=3−1+8=10).

Such receipt, determining/updating and providing of data may be continued to locally maintain and provide up-to-date inventory information. Associated processes are described here with regard to at least FIGS. 8A and 8B, and associated methods 800a and 800b.

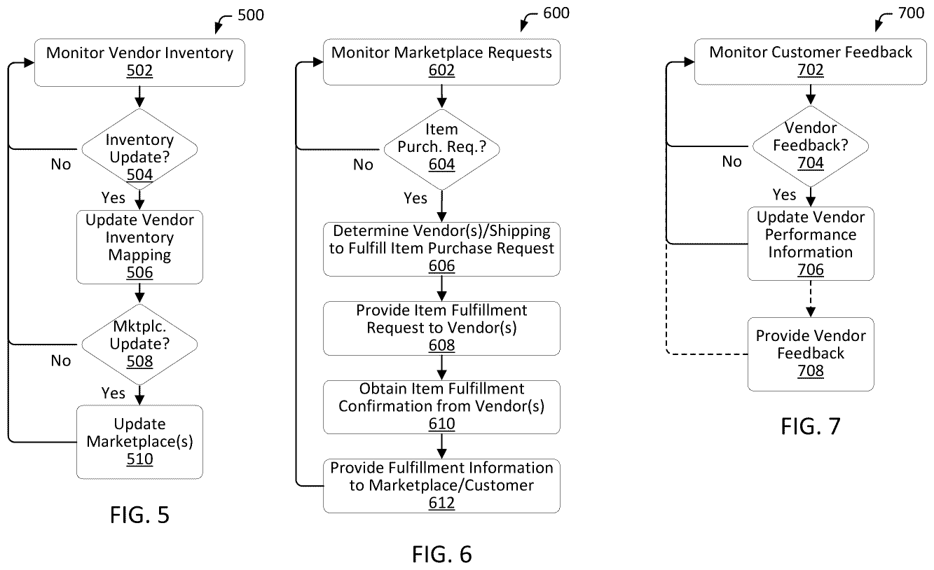

FIG. 5 is a flowchart diagram that illustrates a method 500 of updating vendor inventory information in accordance with one or more embodiments. Some or all of the procedural elements of method 500 may be performed, for example, by the retailer portal 110 (or the retailer or another entity).

Method 500 may include monitoring vendor inventory (block 502). This may include monitoring for vendor provided updates to inventory of items sold through a retailer, as described herein. For example, monitoring vendor inventory may include the retailer portal 110 collecting and assessing vendor information 140 from some or all of the vendors 104-104c, as described herein.

Method 500 may include determining whether an inventory update is needed (block 504).

This may include determining, based on the updates to inventory of items sold through a retailer, whether there is a relevant change in inventory quantity, pricing or descriptions for items sold through the retailer, or relevant change in shipping rates for vendors that service the retailer, as described herein. For example, determining whether an inventory update is needed may include the retailer portal 110 determining whether the vendor information 140 collected indicates a change in inventory quantity, pricing or descriptions of items A-E by any of the vendors 104a-104c, or changes in shipping rates for any of the vendors 104a-104c, as described herein.

Method 500 may include in response to determining that there is not an inventory update needed (at block 504), returning to monitoring vendor inventory (block 502). Method 500 may include in response to determining that there is an inventory update needed (at block 504), proceeding to updating a vendor inventory mapping (block 506). This may include updating retailer information to reflect the changes. For example, proceeding to updating a vendor inventory mapping may include the retailer portal 110 determining, based on the vendor information 140 collected, changes in inventory quantity, pricing, or descriptions for one or more of items A-E, or changes in shipping rates for one or more of the vendors 104a-104c, and updating the retailer information 114 to reflect the changes as described herein. For example, in response to the retailer portal 110 collecting vendor information 140 from vendor A 104a that identifies changes in vendor A's inventory quantity for item A, pricing for item A, or shipping rates for vendor A, and determining, based on the vendor information 140 collected from vendor A, the changes in vendor A's inventory quantity for item A, pricing for item A, and shipping rates for vendor A, the retailer portal 110 may update the retailer information 114, including updating the vendor inventory mapping 126 to reflect the current inventory quantity and pricing for item A, and updating the vendor shipping mapping 128 to reflect the current shipping rates for vendor A.

Method 500 may include determining whether a marketplace update is needed (block 508). This may include determining whether there are changes in retailer information that are relevant to marketplaces that service the retailer, as described herein. For example, determining whether there is marketplace update may include the retailer portal 110 determining whether there are changes to the retailer information 114 (e.g., as a result of the updating of the vendor inventory mappings 126) that are relevant to inventory, pricing, product descriptions or shipping of items A-E offered for sale through the marketplaces 106a-106c, as described herein. Where for example, marketplaces A and B 106a and 106b offer item A for sale through its e-commerce site, vendor inventory operations may include the retailer portal 110 determining that the retailer information 114 indicates a relevant change in inventory and price of item A based on it being sold by one or more of the marketplaces 106a-106c.

Method 500 may include in response to determining that there is not a marketplace update needed (at block 508), returning to monitoring vendor inventory (block 502). Method 500 may include in response to determining that there is a marketplace update needed (at block 508), proceeding to updating marketplace(s) (block 510). This may include generating (and sending to the affected marketplaces) updated marketplace information that corresponds to the changes. Where for example, each of marketplaces A and B 106a and 106b offer item A for sale through its e-commerce site, and the retailer portal 110 determines that the retailer information 114 indicates a change in inventory and price of item A, updating marketplace(s) may include the retailer portal 110, in response, generating updated item information 142 that is indicative of the current inventory and price of item A, determining that each of marketplaces A and B 106a and 106b offer item A for sale through its respective e-commerce site, and sending the updated item information 142 (e.g., indicative of the current inventory and price of item A) to marketplaces A and B 106a and 106b. Marketplaces A and B 106a and 106b may, in turn, update their e-commerce sites to reflect the current inventory and price of item A. For example, marketplaces A and B 106a and 106b may update their sites to display the current inventory and price of item A when users, such as customers 150, navigate to a page offering item A for sale.

FIG. 6 is a flowchart diagram that illustrates a method 600 of fulfilling marketplace purchase requests in accordance with one or more embodiments. Some or all of the procedural elements of method 600 may be performed, for example, by the retailer portal 110 (or the retailer or another entity).

Method 600 may include monitoring for marketplace requests (block 602). This may include monitoring for marketplace requests that include item purchase requests (or “orders”) provided by associated marketplace(s), as described herein. For example, monitoring for marketplace request may include the retailer portal 110 monitoring for marketplace requests 144 received from marketplaces 106a-106c for orders of one or more of items A-E, as described herein.

Method 600 may include determining whether an item purchase request has been generated/received (block 604). This may include determining whether a marketplace request that includes an item purchase request (or “order”) has been generated or received from a marketplace, as described herein. For example, determining whether an item purchase request has been generated/received may include the retailer portal 110 determining whether a marketplace request 144 defined by an order of one or more of items A-E by a customer 150 has been received by the retailer portal 110, as described herein.

Method 600 may include in response to determining that there is not an item purchase request generated/received (at block 604), returning to monitoring for marketplace request (block 602). Method 600 may include in response to determining that there is not an item purchase request generated/received (at block 604), proceeding determining vendor(s)/shipping to fulfill the marketplace request (block 606). This may include identifying one or more vendors and associated shipping methods to provide items to fulfill the marketplace request. For example, in response to the retailer portal 110 receiving a marketplace request 144 including an order by a customer 150 to purchase item A through marketplace A 106a (the order including item information, such as a quantity of item A to be purchased (e.g., Item A Qty=1), and customer information, such as a customer name (e.g., Name=John Doe) and a customer address (e.g., Shipping Address=111 First Street, Phoenix, Arizona 85001), the retailer portal 110 may use the vendor inventory mapping 126 to identify which of the vendors 104a-104c have sufficient inventory to fulfill the marketplace request 144 and associated pricing for item A, identify for the identified vendors associated shipping methods and costs using the vendor shipping mapping 128, selecting, for example based on pricing for item A, the shipping cost, and other factors (e.g., shipping-length/delivery-timeframe, rating of vendors indicated in the vendor performance information), one or more vendors to fulfill the marketplace request 144, such as vendor A 104a. Where, for example, one or more of the vendors identified rely on retailer provided shipping services (e.g., where a vendor does not have an affiliation with a shipping provider), the retailer portal 110 may engage a shipping service (e.g., shipping provider 109) to identify shipping method and cost for the vendor. This may include, for example, the retailer portal 110 engaging with a shipping API (e.g., Shippo API) to fetch an associated shipping method and shipping cost for the vendor.

Method 600 may include providing fulfillment request(s) to vendor(s) (block 608). This may include providing one or more fulfillment request identifying a quantity of items to be provided to a given location, such as the address of a customer that ordered the item(s), as described herein. Continuing with the above example, providing fulfillment request(s) to vendor(s) may include, in response to portal 110 selecting vendor A 104a to fulfill the request for the purchase of 1 of item A, portal 110 sending, to vendor A 104a, a corresponding fulfillment request 146 (e.g., Item A Qty=1; Name=John Doe; Shipping Address=111 First Street, Phoenix, Arizona 85001), as described herein.

Method 600 may include obtaining item fulfillment confirmation from vendor(s) (block 610). This may include receiving confirmation that the item has been shipped by the vendor and any relevant shipping information, as describe herein. Continuing with the above example, where vendor A 104a employs a shipping service to ship item A to fulfill the fulfillment request 146 (and thus, for example, the retailer portal 110 does not initially have access to the shipping information, such a shipping service and tracking information), obtaining item fulfillment confirmation from vendor may include, the retailer portal 110 receiving, from, vendor A 104a shipping information confirming that item A has been sent to the destination address, as well as the shipping service employed and an associated tracking number (e.g., “Confirmation: Item A shipped to John Doe at 111 First Street, Phoenix, Arizona 85001 using FedEx, tracking number 345FD7RNG). Where, for example, vendor A 104a employs a retailer provided shipping service to ship item A to fulfill the fulfillment request 146 (and thus, for example, the retailer portal 110 does initially have access to the shipping information, such a shipping service and tracking information), obtaining item fulfillment confirmation from vendor may include, the retailer portal 110 receiving, from, vendor A 104a shipping information confirming that item A has been sent to the destination address (with or without the shipping service employed and an associated tracking number) (e.g., “Confirmation: Item A shipped to John Doe using retailer provided shipping”).

Method 600 may include providing fulfillment information (e.g., to marketplace/customer) (block 612). This may include providing confirmation of shipping (or associated information) to enable the customer to be provided with confirmation of the shipment, as describe herein. Continuing with the above example, providing fulfillment information to marketplace/customer may include the retailer portal 110, in response to receiving fulfillment confirmation from vendor A 104a, providing corresponding shipping confirmation to the marketplace 106a (e.g., “Confirmation: Item A shipped to John Doe at 111 First Street, Phoenix, Arizona 85001 using FedEx, tracking number 345FD7RNG), which may, in turn, provide corresponding shipping confirmation to the customer 150, or providing (e.g., e-mailing) shipping confirmation to the customer 150.

FIG. 7 is a flowchart diagram that illustrates a method of collecting/updating vendor feedback information in accordance with one or more embodiments. Some or all of the procedural elements of method 700 may be performed, for example, by the retailer portal 110 (or another entity, such as the retailer).

Method 700 may include monitoring customer feedback (block 702). This may include monitoring for vendor feedback information (e.g., from customers or marketplaces) for vendors that service the retailer, as describe herein. For example, monitoring customer feedback may include the retailer portal 110 monitoring for customer feedback surveys provided by customers 150 that are supplied items by vendors 104a-104c, as described herein.

Method 700 may include determining whether vendor feedback has been received (block 704). This may include determining whether vendor feedback information (e.g., from customers or marketplaces) has been received for vendors that service the retailer, as describe herein. For example, determining whether vendor feedback has been received may include the retailer portal 110 determining whether that a customer survey for one or more of the vendors 104a-104c has been received.

Method 700 may include in response to determining that vendor feedback has not been received (at block 706), returning to monitoring customer feedback (block 702). Method 700 may include in response to determining that vendor feedback has been received (at block 704), proceeding to updating vendor performance mapping (block 706). This may include updating vendor performance mapping to reflect the customer feedback. For example, proceeding to updating vendor performance mapping may include the retailer portal 110 determining, based on the customer surveys collected for one or more of the vendor 104a-104c, rating/scores for one or more of the vendors 104a-104c, and recording those scores in respective entries of vendor performance mapping 124. In some embodiments, method 700 may include providing vendor feedback (block 708). For example, the retailer portal 110 may periodically (e.g., daily, weekly, monthly, or the like) inform the vendors 104a-104c of their respective rating/scores.

FIGS. 8A and 8B are flowchart diagrams that illustrate methods of maintaining and reporting inventory in accordance with one or more embodiments. Some or all of the procedural elements of methods 800a and 800b may be performed, for example, by the retailer portal 110. For example, some or all of the procedural elements of method 800a may be performed by the vendor inventory monitor 132, or some or all of the procedural elements of method 800b may be performed by the marketplace manager 134.

Method 800a may include receiving a vendor inventory update (block 802). This may include receiving vendor inventory information that is indicative of a current inventory of one or more items for one or more vendors. For example, receiving a vendor inventory update may include the vendor inventory monitor 132 receiving, from vendors 104a, 104b and 104c, vendor information 140 that is indicative of the current inventory of items A, B, C and D held by the respective vendors 104a, 104b and 104c. This may include, for example, the vendor inventory monitor 132: receiving, at 1:00 pm from vendor 104a (e.g., in an hourly update), vendor information 140 that is indicative of a current inventory of 8 of item A; receiving, at 1:00 pm from vendor 104b (e.g., in an hourly update), vendor information 140 that is indicative of a current inventory of 4 of item C; and receiving, at 1:00 pm from vendor C 104c (e.g., in an hourly update), vendor information 140 that is indicative of a current inventory of 3 of item B, 6 of item C and 7 of item D.

Method 800a may include updating vendor inventory (block 804). This may include updating a vendor inventory mapping (or a similar record) to reflect a current inventory of one or more items, for one or more vendors. Continuing with the prior example, updating vendor inventory may include the vendor inventory monitor 132, based on the received vendor information, determining a current vendor inventory at 1:00 pm of “Vendor A=8 of item A and 1 of item D, Vendor B=4 of item C, and Vendor C=3 of item B, 6 of item C and 7 of item D”, and updating the vendor inventory mapping 126 to reflect the current vendor inventory determined for 1:00 pm.

Method 800a may include providing an updated vendor inventory (block 806). This may include providing to one or more entities, such as a marketplace manager, an updated vendor inventory that is indicative of a current inventory of items held by vendors. For example, providing an updated vendor inventory may include the vendor inventory monitor 132, providing, to the marketplace manager 134, current vendor inventory information that reflects a current vendor inventory, such as current/updated version of the vendor inventory mapping 126. Continuing with the prior example, this may include providing, to the marketplace manager 134 at (or shortly after) 1:00 pm, current vendor inventory information of “Vendor A=8 of item A and 1 of item D, Vendor B=4 of item C, and Vendor C=3 of item B, 6 of item C and 7 of item D”, which corresponds to the vendor inventory mapping 126 at 1:00 pm. In some embodiments, such updated inventory is provided periodically or in response to an associated event. For example, updated vendor inventory information may be provided at a given interval (e.g., every 1 minute, 5 minutes, 10 minutes, 15 minutes, 30 minutes, 1 hour, or the like) or in response to an associated event (e.g., in response to receiving updated inventory information from a vendor, in response to determining a change in the vendor inventory (e.g., a change in the vendor inventory mapping 126), in response to a query from the marketplace manager 134 for current vendor inventory information, or the like).

Method 800b may include monitoring for updated vendor inventory or an item request (block 820). This may include awaiting receipt of updated vendor inventory information or an item request, such as a request to purchase an item held in inventory. For example, monitoring for updated vendor inventory or an item request may include the marketplace manager 134 monitoring for updated inventory information from the vendor inventory monitor 132 or an item purchase request from a marketplace 106. Continuing with the prior example, an item purchase request may include, for example, a request received the marketplace manager 134, from marketplace 106b, for the purchase of 1 of item B by a given customer (e.g., generated in response to marketplace 106b receiving, from the given customer, a request to purchase 1 of item B). As another example, an item purchase request may include, for example, a request, received by the marketplace manager 134, from marketplace 106c, for the purchase of 1 of item D by a given customer (e.g., generated in response to marketplace 106c receiving, from the given customer, a request to purchase 1 of item D).

Method 800b may include in response to receiving updated vendor inventory (block 822), updating a local inventory (block 824). This may include updating a local inventory mapping to reflect the updated vendor inventory received. Continuing with the prior example, this may include the marketplace manager 134 receiving, from vendor inventory monitor 132 at (or shortly after) 1:00 pm, the current vendor inventory information of “Vendor A=8 of item A and 1 of item D, Vendor B=4 of item C, and Vendor C=3 of item B, 6 of item C and 7 of item D” (e.g., via a copy of the corresponding portion of the vendor inventory mapping 126) determined for 1:00 pm and, in response, updating the local inventory record 136 to reflect the current vendor inventory information of “Vendor A=8 of item A and 1 of item D, Vendor B=4 of item C, and Vendor C=3 of item B, 6 of item C and 7 of item D”. In some embodiments, updating a local inventory may include updating the local inventory to reflect a current inventory of kits of items (or “kits”) that are formed from one or more of the individually defined items. Continuing with the above example, the marketplace manager 134 may determine, based on the current inventory information for 1 pm, (e.g., based on max number of kits that can be assembled from available items) a current item/kit inventory of “A=8, B=3, C=10 (e.g., 4+6), D=8 (e.g., 1+7); Kit AB=3 (e.g., based on only 3 of item B being available), Kit AC=8 (e.g., based on only 8 of item A being available), Kit BC/DC=10” (e.g., based on D and B being interchangeable in the kit, to pair with C), and, in response, update the local inventory record 136 to reflect the current item/kit inventory. In some embodiments, prov

Method 800b may include in response to receiving an item request (block 826), fulfilling the item request (block 828) and updating a local inventory (block 824). This may include, in response to receiving and fulfilling an item request that creates a change in inventory, updating a local inventory mapping to reflect the change in inventory. Continuing with the prior example, this may include the marketplace manager 134 receiving, from marketplace 106b at 1:15 pm, a request for customer A to purchase quantity 1 of item B; in response, the marketplace manager 134 selecting vendor C 104c to fulfill the item purchase request of quantity 1 of item B to customer A; in response, the marketplace manager 134 sending vendor C 104c a corresponding fulfillment request, and determining, based on the purchase/fulfillment of qty 1 of item B by vendor C 104c and the local inventory record 136, current vendor inventory information of “Vendor A=8 of item A and 1 of item D, Vendor B=4 of item C, and Vendor C=2 of item B, 6 of item C and 7 of item D” and current item/kit inventory of A=8, B=2 (e.g., 3−1), C=10, D=8; Kit AB=2 (e.g. because only 2 of item B available), Kit AC=8, Kit BC/DC=10 (e.g., BC=2 and DC=8); and in response, the marketplace manager 134 updating the local inventory record 136 to reflect the current vendor inventory information, including the associated item/kit inventories.

As a further example, this may include the marketplace manager 134 then receiving, from marketplace 106c at 1:30 pm, a request for customer B to purchase quantity 1 of item D; in response, the marketplace manager 134 selecting vendor C 104c to fulfill the item purchase request of quantity 1 of item D to customer B; in response, the marketplace manager 134 sending vendor C 104c a corresponding fulfillment request, and determining, based on the purchase/fulfillment of qty 1 of item D by vendor C 104c and the local inventory record 136, current vendor inventory information of “Vendor A=8 of item A and 1 of item D, Vendor B=4 of item C, and Vendor C=2 of item B, 6 of item C and 6 of item D” and current item/kit inventory of A=8, B=2 (e.g., 3−1), C=10, D=7 (e.g., 8−1); Kit AB=2 (e.g., because only 2 of item B available), Kit AC=8, Kit BC/DC=9 (e.g., BC=2 and DC=7); and in response, the marketplace manager 134 updating the local inventory record 136 to reflect the current vendor inventory information and associated item/kit inventories.

Method 800b may include providing local inventory (block 830). This may include providing an indication of a current inventory of items/kits to marketplaces or the like. For example, where marketplace 106a offers items A, B, C and kit AC to customers for purchase, providing local inventory may include the marketplace manager 134 providing a current inventory of items A, B, C and kit AC to marketplace 106a. Continuing with the prior examples, at 1:15 pm, marketplace manager 804 may send, to marketplaces 106a, 106b and 106c, marketplace information 142 that is consistent with the current item/kit inventory of A=8, B=2, C=10, D=8; Kit AB=2, Kit AC=8, Kit BC/DC=10 (e.g., send to marketplace 106a a current inventory of items A=8, B=2, C=10 and kit AC=8 to marketplace 106a). At 1:30 pm, marketplace manager 804 may send, to marketplaces 106a, 106b and 106c, marketplace information 142 that is consistent with the current item/kit inventory of A=8, B=2, C=10, D=7; Kit AB=2, Kit AC=8, Kit BC/DC=9 (e.g., send to marketplace 106a a current inventory of items A=8, B=2, C=10 and kit AC=8 to marketplace 106a). A marketplace 106 may, for example, use the current inventory information to populate displayed quantities individual items or kits that are currently available for purchase.

Referring again to receiving a vendor inventory update (block 802) and updating vendor inventory (block 804), as a further example, at 2:00 pm vendor inventory monitor 132 may receive current vendor information 140 that corresponds to “Vendor A=8 of item A and 1 of item D, Vendor B=4 of item C, and Vendor C=10 of item B, 6 of item C and 7 of item D.” This may, for example, reflect the fulfilment of qty 1 of item B by Vendor C, the fulfilment of qty 1 of item D by vendor 104c, and vendor 104c receiving a shipment of 8 of item B between 1:00 pm and 2:00 pm (e.g., B=3−1+8=10). In response, vendor inventory monitor 132 may provide a corresponding update to marketplace manager 134, and marketplace manager 134 may in turn employ the information as a basis to update the local inventory record (block 824), fulfill item requests (block 828), provide local inventory (block 830), and so forth.

FIG. 9 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the entities described (e.g., retailer portal 110, vendors 104a-104c, marketplaces 106a-106c or shipping provider(s) 109), the vendor inventory monitor 132, the marketplace manager 134, method 500, 600, 700, 800a or 800b.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments.

Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A retailer management system comprising:
a retailer database storing retailer information comprising:
   a marketplace mapping comprising a mapping of retailer item identifiers employed by a retailer for items sold through the retailer to marketplace item identifiers employed by one or more electronic commerce marketplaces;
   a vendor inventory mapping comprising a mapping of inventory information for the items sold through the retailer to vendor locations that service the marketplace; and
   a vendor shipping mapping comprising a mapping of shipping cost information for the items sold through the retailer to vendor locations that service the marketplace; and a retailer management portal system comprising:
   non-transitory computer readable storage medium comprising program instructions stored thereon that are executable by a processor to perform the following operations for fulfilling orders for items:
      receiving, from an electronic commerce marketplace, a marketplace request indicating a request for a customer to purchase an item sold through the retailer, the marketplace request indicating:
         a marketplace item identifier associated with the item;
         a quantity of the item to be purchased; and
         a customer location;
      determining, based on the marketplace item identifier and the marketplace mapping, a retailer item identifier associated with the item;
      determining, based on the retailer item identifier, the vendor inventory mapping and the vendor shipping mapping, one or more vendor locations to provide the quantity of the item the customer location; and
      sending, to one or more vendors associated with the one or more vendor locations, one or more fulfillment requests to ship a given quantity of the item to the customer location.

2. The system of embodiment 1, wherein the marketplace mapping comprises, for each of different items sold through the retailer, a mapping of a retailer identifier employed by the retailer for the item to a marketplace identifier employed by an electronic commerce marketplace that services sales of items for the retailer.

3. The system of embodiment 2, the operations further comprising:
obtaining, from one or more marketplaces that service the retailer, marketplace identifier information comprising an indication of marketplace identifiers employed electronic commerce marketplaces that service the retailer; and
generating, based on the marketplace identifier information obtained, the marketplace mapping.

4. The system of any one of embodiments 1-3, wherein the vendor inventory mapping comprises, for each of different items and vendor locations that service the item, a mapping to inventory information comprising a quantity of the item available at the vendor location and a price of the item at the location.

5. The system of embodiment 4, the operations further comprising:
obtaining, from one or more vendors that service the retailer, vendor inventory information comprising an indication of quantity and price of one or more items available at one or more of the vendor locations that service the retailer; and
generating, based on the vendor inventory information obtained, the vendor inventory mapping.

6. The system of any one of embodiments 1-5, wherein the vendor shipping mapping comprises, for each of different vendor locations that service the retailer, shipping cost information that indicates cost to ship items from the vendor location to customers.

7. The system of embodiment 6, the operations further comprising:
obtaining historical shipping cost information for the vendor locations that service the marketplace; and
generating, based on the historical shipping cost information for the vendor locations that service the marketplace, the vendor shipping mapping.

8. The system of embodiment 6, the operations further comprising:
receiving, from one or more vendors that service the retailer, shipping cost information for vendor locations that service the marketplace; and
generating, based on the shipping cost information for the vendor locations that service the retailer received, the vendor shipping mapping.

9. The system of any one of embodiments 1-8, wherein the one or more vendors associated with the one or more vendor locations are configured to send the given quantity of the item to the customer location in accordance with the one or more fulfillment requests.

10. The system of any one of embodiments 1-9, the operations further comprising:
receiving, from the one or more vendors associated with the one or more vendor locations, shipping information indicative of shipping of a given quantity of the item to the customer location; and
sending, to the marketplace in response to receipt of the shipping information, shipping confirmation information indicative of the shipping of the given quantity of the item to the customer location.

11. The system of any one of embodiments 1-10, wherein determining, based on the retailer item identifier, the vendor inventory mapping and the vendor shipping mapping, one or more vendor locations to provide the quantity of the item to be purchased to the customer location comprises:
determining, based on the vendor inventory mapping, a vendor location having available inventory of the item and a price for purchasing the item from the vendor location;
determining, based on the vendor shipping mapping, a cost to ship the item from the vendor location to the customer location; and
determining, based on the price for purchasing the item from the vendor location and the cost to ship the item from the vendor location to the customer location, the one or more vendor locations to provide the quantity of the item. 12. The system of any one of embodiments 1-11, the operations further comprising:

obtaining, from a shipping provider, shipping information to be used to send a given quantity of the item to be purchased to the customer location,
wherein one or more of the fulfillment requests to send a given quantity of the item to be purchased to the customer location comprise the shipping information.

13. The system of embodiment 12, wherein the shipping information comprises a shipping label.

14. The system of any one of embodiments 1-13, the operations further comprising:
receiving vendor inventory information;
determining, based on the vendor inventory information, a local inventory indicative of a quantity of items available for purchase by way of a vendor;
providing, to one or more marketplaces, inventory information corresponding to the local inventory;
fulfilling an item purchase request;
updating, based on the fulfilling of the item purchase request, the local inventory to generate an updated local inventory;
providing, to the one or more marketplaces, updated inventory information corresponding to the updated local inventory;
receiving second vendor inventory information; and updating, based on the second vendor inventory information, the updated local inventory.

15. A method of managing retail sales, the method comprising:
receiving, by a retailer management portal system from an electronic commerce marketplace, a marketplace request indicating a request for a customer to purchase an item sold through a retailer, the marketplace request indicating:
   a marketplace item identifier associated with the item;
   a quantity of the item to be purchased; and
   a customer location;
determining, by the retailer management portal system based on the marketplace item identifier and a marketplace mapping, a retailer item identifier associated with the item,
   the marketplace mapping comprising a mapping of retailer item identifiers employed by the retailer for items sold through the retailer to marketplace item identifiers employed by one or more electronic commerce marketplaces;
determining, by the retailer management portal system based on the retailer item identifier, a vendor inventory mapping and a vendor shipping mapping, one or more vendor locations to provide the quantity of the item the customer location,
   the vendor inventory mapping comprising a mapping of inventory information for the items sold through the retailer to vendor locations that service the marketplace, and
   the vendor shipping mapping comprising a mapping of shipping cost information for the items sold through the retailer to vendor locations that service the marketplace;
sending, by retailer management portal system to one or more vendors associated with the one or more vendor locations, one or more fulfillment requests to ship a given quantity of the item to the customer location.

16. The method of embodiment 15, wherein the marketplace mapping comprises, for each of different items sold through the retailer, a mapping of a retailer identifier employed by the retailer for the item to a marketplace identifier employed by an electronic commerce marketplace that services sales of items for the retailer.

17. The method of embodiment 16, further comprising:
obtaining, by the retailer management portal system from one or more marketplaces that service the retailer, marketplace identifier information comprising an indication of marketplace identifiers employed electronic commerce marketplaces that service the retailer; and
generating, by the retailer management portal system based on the marketplace identifier information obtained, the marketplace mapping.

18. The method of any one of embodiments 15-17, wherein the vendor inventory mapping comprises, for each of different items and vendor locations that service the item, a mapping to inventory information comprising a quantity of the item available at the vendor location and a price of the item at the location.

19. The method of embodiment 18, further comprising:
obtaining, by the retailer management portal system from one or more vendors that service the retailer, vendor inventory information comprising an indication of quantity and price of one or more items available at one or more of the vendor locations that service the retailer; and
generating, by the retailer management portal system based on the vendor inventory information obtained, the vendor inventory mapping.

20. The method of any one of embodiments 15-19, wherein the vendor shipping mapping comprises, for each of different vendor locations that service the retailer, shipping cost information that indicates cost to ship items from the vendor location to customers.

21. The method of embodiment 20, further comprising:
obtaining, by the retailer management portal system, historical shipping cost information for the vendor locations that service the marketplace; and
generating, by the retailer management portal system based on the historical shipping cost information for the vendor locations that service the marketplace, the vendor shipping mapping.

22. The method of embodiment 20, further comprising:
receiving, by the retailer management portal system from one or more vendors that service the retailer, shipping cost information for vendor locations that service the marketplace; and
generating, by the retailer management portal system based on the shipping cost information for the vendor locations that service the retailer received, the vendor shipping mapping.

23. The method of any one of embodiments 15-22, wherein the one or more vendors associated with the one or more vendor locations are configured to send the given quantity of the item to the customer location in accordance with the one or more fulfillment requests.

24. The method of any one of embodiments 15-23, further comprising:
receiving, by the retailer management portal system from the one or more vendors associated with the one or more vendor locations, shipping information indicative of shipping of a given quantity of the item to the customer location; and
sending, by the retailer management portal system to the marketplace in response to receipt of the shipping information, shipping confirmation information indicative of the shipping of the given quantity of the item to the customer location.

25. The method of any one of embodiments 15-24, wherein determining, based on the retailer item identifier, the vendor inventory mapping and the vendor shipping mapping, one or more vendor locations to provide the quantity of the item to be purchased to the customer location comprises:
determining, by the retailer management portal system based on the vendor inventory mapping, a vendor location having available inventory of the item and a price for purchasing the item from the vendor location;
determining, by the retailer management portal system based on the vendor shipping mapping, a cost to ship the item from the vendor location to the customer location; and
determining, by the retailer management portal system based on the price for purchasing the item from the vendor location and the cost to ship the item from the vendor location to the customer location, the one or more vendor locations to provide the quantity of the item.

26. The method of any one of embodiments 15-25, further comprising:
obtaining, by the retailer management portal system from a shipping provider, shipping information to be used to send a given quantity of the item to be purchased to the customer location,
wherein one or more of the fulfillment requests to send a given quantity of the item to be purchased to the customer location comprise the shipping information.

27. The method of embodiment 25, wherein the shipping information comprises a shipping label.

28. The method of any one of embodiments 15-27, further comprising:
receiving, by the retailer management portal system, vendor inventory information;
determining, by the retailer management portal system based on the vendor inventory information, a local inventory indicative of a quantity of items available for purchase by way of a vendor;
providing, by the retailer management portal system to one or more marketplaces, inventory information corresponding to the local inventory;
fulfilling, by the retailer management portal system, an item purchase request;
updating, by the retailer management portal system based on the fulfilling of the item purchase request, the local inventory to generate an updated local inventory;
providing, by the retailer management portal system to the one or more marketplaces, updated inventory information corresponding to the updated local inventory;
receiving, by the retailer management portal system, second vendor inventory information; and
updating, by the retailer management portal system based on the second vendor inventory information, the updated local inventory.

29. A non-transitory computer readable storage medium comprising program instructions stored thereon that are executable by a processor to perform the method operations of any one or embodiments 14-28.

What is claimed is:

1. A retailer management system comprising:
a retailer database storing retailer information comprising:
a marketplace mapping comprising a mapping of retailer item identifiers employed by a retailer for items sold through the retailer to marketplace item identifiers employed by one or more electronic commerce marketplaces;
a vendor inventory mapping comprising a mapping of inventory information for the items sold through the retailer to vendor locations that service the marketplace; and
a vendor shipping mapping comprising a mapping of shipping cost information for the items sold through the retailer to vendor locations that service the marketplace; and
a retailer management portal system comprising:
non-transitory computer readable storage medium comprising program instructions stored thereon that are executable by a processor to perform the following operations for fulfilling orders for items:
receiving, from an electronic commerce marketplace, a marketplace request indicating a request for a customer to purchase an item sold through the retailer, the marketplace request indicating:
a marketplace item identifier associated with the item;
a quantity of the item to be purchased; and
a customer location;
determining, based on the marketplace item identifier and the marketplace mapping, a retailer item identifier associated with the item;
determining, based on the retailer item identifier, the vendor inventory mapping and the vendor shipping mapping, one or more vendor locations to provide the quantity of the item the customer location; and
sending, to one or more vendors associated with the one or more vendor locations, one or more fulfillment requests to ship a given quantity of the item to the customer location.

2. The system of claim 1, wherein the marketplace mapping comprises, for each of different items sold through the retailer, a mapping of a retailer identifier employed by the retailer for the item to a marketplace identifier employed by an electronic commerce marketplace that services sales of items for the retailer.

3. The system of claim 2, the operations further comprising:
obtaining, from one or more marketplaces that service the retailer, marketplace identifier information comprising an indication of marketplace identifiers employed electronic commerce marketplaces that service the retailer; and
generating, based on the marketplace identifier information obtained, the marketplace mapping.

4. The system of claim 1, wherein the vendor inventory mapping comprises, for each of different items and vendor locations that service the item, a mapping to inventory information comprising a quantity of the item available at the vendor location and a price of the item at the location.

5. The system of claim 1, wherein the vendor shipping mapping comprises, for each of different vendor locations that service the retailer, shipping cost information that indicates cost to ship items from the vendor location to customers.

6. The system of claim 6, the operations further comprising:
obtaining historical shipping cost information for the vendor locations that service the marketplace; and
generating, based on the historical shipping cost information for the vendor locations that service the marketplace, the vendor shipping mapping.

7. The system of claim 6, the operations further comprising:
receiving, from one or more vendors that service the retailer, shipping cost information for vendor locations that service the marketplace; and
generating, based on the shipping cost information for the vendor locations that service the retailer received, the vendor shipping mapping.

8. The system of claim 1, wherein the one or more vendors associated with the one or more vendor locations are configured to send the given quantity of the item to the customer location in accordance with the one or more fulfillment requests.

9. The system of claim 1, the operations further comprising:
receiving vendor inventory information;
determining, based on the vendor inventory information, a local inventory indicative of a quantity of items available for purchase by way of a vendor;
providing, to one or more marketplaces, inventory information corresponding to the local inventory;
fulfilling an item purchase request;
updating, based on the fulfilling of the item purchase request, the local inventory to generate an updated local inventory;
providing, to the one or more marketplaces, updated inventory information corresponding to the updated local inventory;
receiving second vendor inventory information; and
updating, based on the second vendor inventory information, the updated local inventory.

10. A method of managing retail sales, the method comprising:
receiving, by a retailer management portal system from an electronic commerce marketplace, a marketplace request indicating a request for a customer to purchase an item sold through a retailer, the marketplace request indicating:
a marketplace item identifier associated with the item;
a quantity of the item to be purchased; and
a customer location;
determining, by the retailer management portal system based on the marketplace item identifier and a marketplace mapping, a retailer item identifier associated with the item,
the marketplace mapping comprising a mapping of retailer item identifiers employed by the retailer for items sold through the retailer to marketplace item identifiers employed by one or more electronic commerce marketplaces;
determining, by the retailer management portal system based on the retailer item identifier, a vendor inventory mapping and a vendor shipping mapping, one or more vendor locations to provide the quantity of the item the customer location,
the vendor inventory mapping comprising a mapping of inventory information for the items sold through the retailer to vendor locations that service the marketplace, and
the vendor shipping mapping comprising a mapping of shipping cost information for the items sold through the retailer to vendor locations that service the marketplace;
sending, by retailer management portal system to one or more vendors associated with the one or more vendor locations, one or more fulfillment requests to ship a given quantity of the item to the customer location.

11. The method of claim 14, wherein the marketplace mapping comprises, for each of different items sold through the retailer, a mapping of a retailer identifier employed by the retailer for the item to a marketplace identifier employed by an electronic commerce marketplace that services sales of items for the retailer.

12. The method of claim 15, further comprising:
obtaining, by the retailer management portal system from one or more marketplaces that service the retailer, marketplace identifier information comprising an indication of marketplace identifiers employed electronic commerce marketplaces that service the retailer; and
generating, by the retailer management portal system based on the marketplace identifier information obtained, the marketplace mapping.

13. The method of claim 14, wherein the vendor inventory mapping comprises, for each of different items and vendor locations that service the item, a mapping to inventory information comprising a quantity of the item available at the vendor location and a price of the item at the location.

14. The method of claim 14, wherein the vendor shipping mapping comprises, for each of different vendor locations that service the retailer, shipping cost information that indicates cost to ship items from the vendor location to customers.

15. The method of claim 19, further comprising:
obtaining, by the retailer management portal system, historical shipping cost information for the vendor locations that service the marketplace; and
generating, by the retailer management portal system based on the historical shipping cost information for the vendor locations that service the marketplace, the vendor shipping mapping.

16. The method of claim 19, further comprising:
receiving, by the retailer management portal system from one or more vendors that service the retailer, shipping cost information for vendor locations that service the marketplace; and
generating, by the retailer management portal system based on the shipping cost information for the vendor locations that service the retailer received, the vendor shipping mapping.

17. The method of claim 14, wherein the one or more vendors associated with the one or more vendor locations are configured to send the given quantity of the item to the customer location in accordance with the one or more fulfillment requests.

18. The method of claim 14, further comprising:
receiving, by the retailer management portal system, vendor inventory information;
determining, by the retailer management portal system based on the vendor inventory information, a local inventory indicative of a quantity of items available for purchase by way of a vendor;
providing, by the retailer management portal system to one or more marketplaces, inventory information corresponding to the local inventory;
fulfilling, by the retailer management portal system, an item purchase request;
updating, by the retailer management portal system based on the fulfilling of the item purchase request, the local inventory to generate an updated local inventory;
providing, by the retailer management portal system to the one or more marketplaces, updated inventory information corresponding to the updated local inventory;
receiving, by the retailer management portal system, second vendor inventory information; and
updating, by the retailer management portal system based on the second vendor inventory information, the updated local inventory.

19. A non-transitory computer readable storage medium comprising program instructions stored thereon that are executable by a processor to perform the following operations for managing retail sales:
receiving, by a retailer management portal system from an electronic commerce marketplace, a marketplace request indicating a request for a customer to purchase an item sold through a retailer, the marketplace request indicating:
a marketplace item identifier associated with the item;
a quantity of the item to be purchased; and
a customer location;
determining, by the retailer management portal system based on the marketplace item identifier and a marketplace mapping, a retailer item identifier associated with the item,
the marketplace mapping comprising a mapping of retailer item identifiers employed by the retailer for items sold through the retailer to marketplace item identifiers employed by one or more electronic commerce marketplaces;
determining, by the retailer management portal system based on the retailer item identifier, a vendor inventory mapping and a vendor shipping mapping, one or more vendor locations to provide the quantity of the item the customer location,
the vendor inventory mapping comprising a mapping of inventory information for the items sold through the retailer to vendor locations that service the marketplace, and
the vendor shipping mapping comprising a mapping of shipping cost information for the items sold through the retailer to vendor locations that service the marketplace;
sending, by retailer management portal system to one or more vendors associated with the one or more vendor locations, one or more fulfillment requests to ship a given quantity of the item to the customer location.
